(19) United States
(12) Patent Application Publication
(10) Pub. No.: US 2025/0138920 A1
(43) Pub. Date: May 1, 2025

(54) AUTOMATIC GENERATION AND UPDATION OF DIALOG FLOWS WITH NEW CAPABILITIES

(71) Applicant: International Business Machines Corporation, Armonk, NY (US)

(72) Inventors: Manish Kesarwani, Bengaluru (IN); Ankush Gupta, Uttarakhand (IN); Arvind Agarwal, New Delhi (IN); Binayak Dutta, Pune (IN); Soujanya Soni, Bangalore (IN); Sameep Mehta, Bangalore (IN)

(21) Appl. No.: 18/495,341

(22) Filed: Oct. 26, 2023

(51) Int. Cl. G06F 9/54

(52) U.S. Cl. CPC G06F 9/547

(57) ABSTRACT

Various systems and methods are presented regarding implementing one or more capabilities into a dialog flow occurring at an automated interface (e.g., a chatbot). A capability can be invoked at the interface in accordance with a user's requirements, e.g., the capability is a function to review data. An application programming interface (API) can be generated from the capability, wherein the API has features, parameters, metadata, etc., generated based on those of the capability. The API can be incorporated into a dialog, wherein the dialog can be subsequently presented on the interface (e.g., as part of a dialog flow). Interaction between the user and the dialog can cause the capability to be executed. Based upon the API features, etc., the API can be incorporated into a dialog, for example, by cloning a dialog, appending a dialog with the API, replacing a pre-existing API with the API in a dialog, and suchlike.

### BACKGROUND

Exploration and quality analysis of datasets are essential processes in the artificial intelligence (AI) pipeline, however such tasks can be tedious endeavors. A variety of data quality and analysis toolkits (e.g., semantic data analysis) are available, providing easy access to state-of-the-art algorithms developed to improve the quality of a dataset, for example. Such toolkits can provide abundant information and extensive capabilities. However, taking full advantage of the toolkits can often require a data administrator has extensive technical expertise and experience to determine what toolkits and capabilities are available and/or best suited to conduct particular activities and functionality (e.g., explore a dataset and/or review quality of data within the dataset).

The above-described background is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements, or delineate any scope of the different embodiments and/or any scope of the claims. The sole purpose of the Summary is to present some concepts in a simplified form as a prelude to the more detailed description presented herein.

In one or more embodiments described herein, systems, devices, computer-implemented methods, methods, apparatus and/or computer program products are presented to enable new, or updated, capabilities to be incorporated into existing or newly created dialog flows for user interaction with an automated interface, such as a chatbot. Automated review and incorporation of a capability into a dialog flow can be conducted such that the capability is presented to an end-user in a meaningful manner that pertains to one or more tasks being conducted by the end-user.

According to one or more embodiments, a system is provided that can auto-update, auto-replace, and/or auto-append capabilities/APIs in dialog trees based on identifying the presence of an already existing capability/API that are similar to newly created capabilities/APIs. Similarity between capabilities/APIs can be based on pertaining to same/similar entities, intents, and suchlike. The system can comprise a memory that stores computer executable components and a processor that executes the computer executable components stored in the memory. The computer executable components can comprise a dialog generator component configured to determine at least one property of a first application programming interface (API) code, and further determine existence of a second API based on the second API having a property similar to the at least one property of the first API, wherein the second API can have an associated dialog configured to be presented during a virtual conversation. In an embodiment, the dialog generator component can be further configured to, in response to a determination that a second API exists similar to the first API, identify the dialog associated with the second API, and further incorporate the first API into the dialog, wherein the dialog comprises the first API and the second API.

In another embodiment, the dialog generator component can be further configured to, in response to a determination that a second API exists similar to the first API, identify the dialog associated with the second API and replace the second API in the dialog with the first API. In a further embodiment, the dialog generator component can be further configured to identify a dialog tree that pertains to the at least one property of the first API, and further identify a node in the dialog tree at which to insert the dialog comprising the first API. In an embodiment, the system can further comprise a human-machine-interface (HMI), wherein the HMI is configured to present, during the virtual conversation, the dialog comprising the first API. In another embodiment, the dialog generator component can be further configured to determine interaction with the dialog comprising the first API, and in response to a determination that the interaction requires activation of the first API, execute the API.

In another embodiment, the computer executable components can further comprise a feedback component configured to receive feedback regarding at least one of the activation of the API, the correlation between the API and a task to be performed, correlation between the API and a theme of the dialog tree, or location of the API in the dialog tree structure. In another embodiment, the feedback component can be further configured to generate feedback information based on the received feedback, and transmit the feedback information to the dialog generator component. In an embodiment, the dialog generator component can be further configured to receive the feedback information, and based on the feedback information, review a location of the dialog in the dialog tree or the suitability of the first API regarding at least one of a theme of the dialog tree or a task being conducted during the virtual conversation.

In another embodiment the dialog generator component can be further configured to, in response to a determination that a second API having a similar property to the at least one property of the first API does not exist, identify a dialog template, generate a dialog based on the dialog template, and incorporate the first API into the dialog.

In another embodiment the dialog generator component can be further configured to, in response to a determination that a second API having a similar property to the at least one property of the first API exists, identify the dialog associated with the second API, further clone the dialog to create a cloned version of the dialog associated with the second API, and incorporate the first API into the cloned dialog.

In an embodiment, the at least one property can include an entity or an intent.

In another embodiment, the computer executable components can further comprise a chatbot, wherein the virtual conversation is presented via the chatbot.

In other embodiments, elements described in connection with the disclosed systems can be embodied in different forms such as computer-implemented methods, computer program products, or other forms. For example, in an embodiment, a computer-implemented method can be performed by a device operatively coupled to a processor, wherein the method can comprise determining at least one property of a first application programming interface (API) code and further determining existence of a second API based on the second API having a property similar to the at least one property of the first API, wherein the second API has an associated dialog configured to be presented during a virtual conversation. In an embodiment, the computer-implemented method can further comprise, in response to determining that a second API exists similar to the first API, identifying the dialog associated with the second API, and incorporating the first API into the dialog, wherein the dialog comprises the first API and the second API. In a further embodiment, the first API can be incorporated into the dialog by replacing the second API with the first API to create a dialog comprising the first API or appending the second API with the first API to create a dialog comprising the first API and the second API. In another embodiment, the computer-implemented method can further comprise in response to determining that a second API having a similar property to the first API does not exist, (i) generating a second dialog, and (ii) incorporating the first API into the second dialog, wherein the second dialog comprises the first API.

In another embodiment, the computer-implemented method can further comprise identifying a dialog tree pertaining to the at least one property of the first API and identifying a node in the dialog tree at which to insert the dialog comprising the first API. In a further embodiment, the computer-implemented method can further comprise determining interaction with the dialog comprising the first API, and in response to determining the interaction requires activation of the first API, executing the API.

Further embodiments can include a computer program product comprising a computer readable storage medium having program instructions embodied therewith, the program instructions executable by a processor can cause the processor to determine, by the processor, at least one property of a first API code, and determine existence of a second API based on the second API having a property similar to the at least one property of the first API, wherein the second API has an associated dialog configured to be presented during a virtual conversation. The program instructions can further cause the processor to, in response to determining that a second API exists similar to the first API, identify the dialog associated with the second API and incorporate the first API into the dialog, wherein the dialog can comprise the first API and the second API, wherein the first API can be incorporated into the dialog by replacing the second API with the first API to create a dialog comprising the first API or appending the second API with the first API to create a dialog comprising the first API and the second API. In an embodiment, the at least one property can include an entity or an intent. In an embodiment, the program instructions can further cause the processor to present the virtual conversation via a chatbot.

### DESCRIPTION OF THE DRAWINGS

One or more embodiments are described below in the Detailed Description section with reference to the following drawings:

FIG. 1 illustrates a system comprising an analytical chatbot system architecture to facilitate incorporation of various capabilities into, and presentment with, a chatbot application, in accordance with one or more embodiments.

FIG. 2A presents a schematic illustrating a dialog tree and respective structure, wherein the dialog tree can be navigated during an interaction between an end-user and a virtual assistant such as a chatbot, according to one or more embodiments.

FIGS. 2B-C present example screens of a dialog flow generated during user interaction with a virtual assistant regarding uploading and executing a capability/API.

FIG. 2D presents a schematic of a dialog flow generated during user interaction with a virtual assistant regarding uploading and executing a capability/API.

FIG. 3 presents a computer-implemented methodology for generating a capability, incorporating the capability into an API, and further presenting the capability during user interaction, in accordance with one or more embodiments

FIG. 4A, presents an example screen during an exchange between an analytical chatbot system and a user onboarding a new capability, in accordance with an embodiment.

FIG. 4B presents a computer-implemented methodology for incorporating a new capability into a dialog flow as a function of an associated API, in accordance with one or more embodiments.

FIG. 4C presents a dialog flow generated during user interaction with a virtual assistant during uploading of a new capability/API, in accordance with an embodiment.

FIG. 4D presents a dialog flow generated during user interaction with a virtual assistant during uploading and executing of a new capability/API, in accordance with an embodiment.

FIG. 5A presents a screen generated during an example exchange between a user and an analytical chatbot system, in accordance with an embodiment.

FIG. 5B presents a computer-implemented methodology for incorporating a new capability into a dialog flow as a function of an associated API, in accordance with one or more embodiments.

FIG. 5C presents a dialog flow generated during user interaction with a virtual assistant during executing an appended new capability/API, in accordance with an embodiment.

FIG. 5D, presents a dialog flow generated during user interaction with a virtual assistant during uploading and executing of a new capability/API, wherein the new capability/API is appended to an existing dialog, in accordance with an embodiment.

FIG. 6 presents a computer-implemented methodology whereby a user can be prompted to authorize the results of automatically updating a pre-existing dialog with a new capability/API, in accordance with one or more embodiments.

FIG. 7A presents a dialog flow an example exchange between an analytical chatbot system and a user, whereby the user wants to replace a currently existing capability with an updated version, in accordance with an embodiment.

FIG. 7B presents a computer-implemented methodology, whereby a user can be prompted as to whether the user wishes to replace an existing capability/API with a new capability/API, or add the new capability/API to an existing capability/API, in accordance with one or more embodiments.

FIG. 7C presents a dialog flow generated during user interaction with a virtual assistant after a capability/API has been updated with a more recent version, in accordance with an embodiment.

FIG. 8 depicts an example schematic block diagram of a computing environment with which the disclosed subject matter can interact/be implemented at least in part, in accordance with various aspects and implementations of the subject disclosure.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be appreciated that while the various embodiments and examples presented herein are directed to a new, or updated, capability being incorporated into a newly created, or already existing dialog tree, to enable an end-user to perform data analysis tasks, the various embodiments are not so limited and can be applied to any situation regarding incorporation of a capability into a dialog, wherein, for example, the dialog is presented via an automated interface such as a chatbot.

As previously mentioned, data exploration and quality analysis are essential yet potentially onerous processes in the machine learning/AI pipeline. A variety of tools (e.g., business intelligence (BI) tools) are available to assist in the analysis/processing of a dataset and to further help explore various properties of the dataset. The variety of tools/toolkits comprise numerous state-of-the-art algorithms and suchlike, providing easy and expedited data analysis and quality improvement. While such algorithms and toolkits can have extensive capabilities and provide a wealth of information, it frequently requires a user (e.g., a data administrator) having technical expertise and experience to determine what toolkits and capabilities are available and/or best suited to perform a particular task (e.g., explore a dataset and/or review quality of data within the dataset). Hence, issues can arise regarding how to incorporate a new capability into a dialog flow that presents the new capability to an end-user in a meaningful and timely manner regarding a task the end-user wishes to perform, e.g., via an automated interface such as a chatbot. The various embodiments presented herein pertain to utilizing computer-implemented AI technology and techniques to gain understanding of a capability, the properties of the capability and associated API, and how to deploy the capability during an interaction via chatbot, for example.

To enable understanding of the various embodiments and concepts presented herein, the following terms are generally described. It is to be appreciated that the descriptions are simply presented here for reference, they are non-limiting, and other meanings and concepts can be equally ascribed to the scope and implementation of a term.

Analytical Chatbot Systems. An analytical chatbot system (ACS) enables both a first user (e.g., a data administrator) to incorporate one or more capabilities into various automated applications, as well as a second user (e.g., an end-user, a client) to conduct data analysis activities with the one or more incorporated capabilities via an easy-to-use and interactive automated interface (e.g., a chatbot and suchlike). A chatbot is a software application configured to enable conversation between a user and an application, wherein the conversation can occur by any suitable means, e.g., via text, text-to-speech (TTS), verbally, speech to text, and suchlike. In a non-limiting example, the term ACS is used herein to denote any platform providing any of the following capabilities to assist a user with their data-related requirements/activities:
i) ACSs are available with a suite of capabilities to help end-users address various data activities (e.g., reviewing a dataset).
ii) end-users can point to a data source or upload new datasets, and initiate automated/functional goals such as analyzing or cleaning a dataset.
iii) ACSs can understand/determine a user's persona (e.g., vocabulary, favoured lexicon, dialect, and suchlike) and can use the user's persona to configure the interactive dialog flow between the user and a chatbot to assist the user in achieving their particular goals during their interaction with the chatbot, e.g., uploading a capability/API, analyzing a dataset.
iv) ACSs enable users (e.g., data administrators) tasked with creating dialog trees and dialog flows to achieve their goals while following the Low-Code and No-Code paradigms.

Application Programming Interface (API). An API can be a software interface between two computer programs. Accordingly, per the various embodiments presented herein, an API can be considered to be the connection between functionality/interaction (e.g., a first computer program) presented at the user interface (e.g., a chatbot presented on a graphical user interface (GUI)) and a function performed by the underlying computer system, where the function can be a capability (e.g., a second computer program). Hence, per the various embodiments presented herein, a capability nests within an API, with the API being configured to interact with the various activities being performed at the user interface, be automatically incorporated into a dialog tree, and suchlike. As part of incorporating a capability into an API, the respective features, attributes, parameters, etc., pertaining to the capability can be identified and subsequently used to incorporate the capability into the API, such that the API has meaningful information (e.g., metadata about the functionality of the API and/or the capability) to enable the API and capability to be identified and/or meaningfully incorporated into construction of a dialog tree.

Capability generally refers to a software function, process, routine, and suchlike, that can be applied to an item of interest. Per the example scenarios presented herein, a capability can be a software function applied to a dataset, wherein, such example capabilities include missing value identification, missing value imputation, class parity, etc. Capabilities can be collected in a toolbox, e.g., an AI toolbox. As part of incorporating a capability into an API, the respective features, attributes, parameters, etc., pertaining to the capability can be identified and subsequently used to incorporate the capability into the API, such that the API has meaningful information (e.g., metadata about the capability) enabling the API and capability to be identified and incorporated into a dialog flow. In an embodiment, the API metadata exposes the features, etc., of the API enabling the functionality of the API to be reviewed, and if deemed applicable, the API can be incorporated into a dialog tree, for example.

Data Extract, Transform, Load (ETL) represents a data integration process that can combine data from multiple data sources into a single, consistent data store that can be loaded into a data warehouse or other target system. ETL can provide the foundation for data analytics and machine learning workstreams. Through a series of business rules, ETL can clean and organize data to address specific business intelligence needs (e.g., monthly reporting), but ETL can also tackle more advanced analytics, which can improve back-end processes or end-user experiences (e.g., as undertaken at the analytical chatbot system). ETL can be utilized to extract data from APIs, cleanse data to improve data quality/data consistency, manage data, and suchlike.

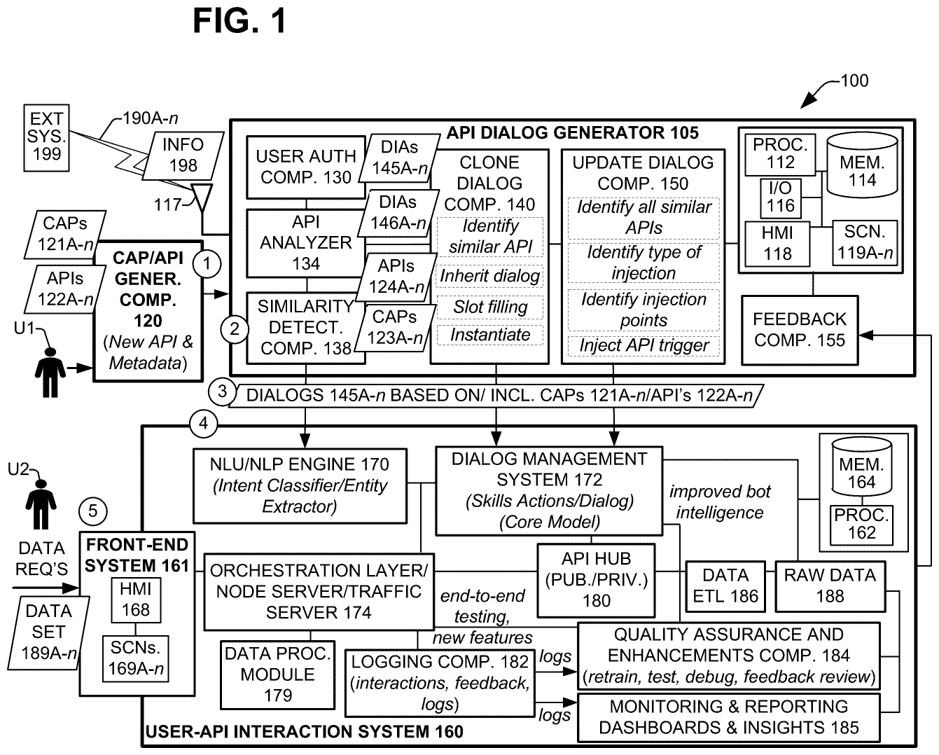

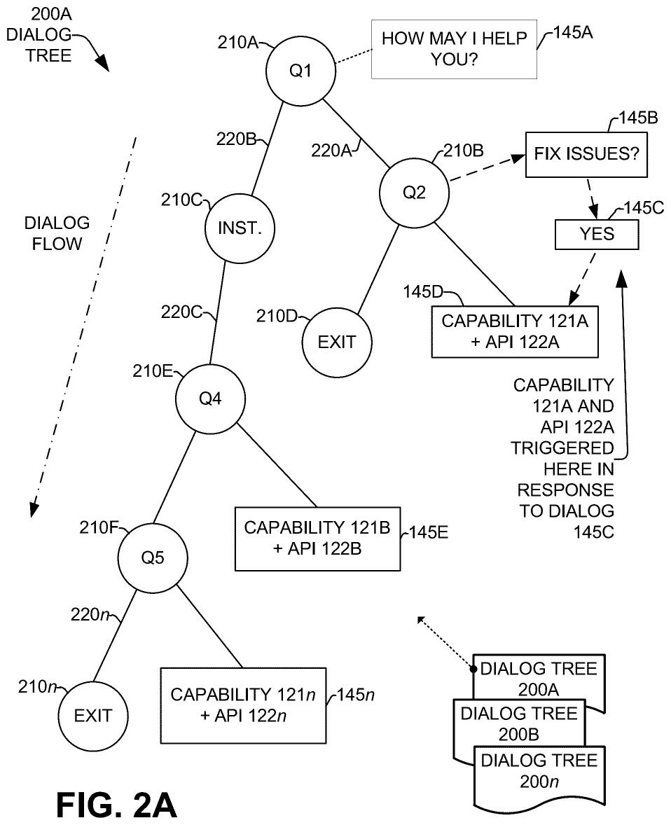

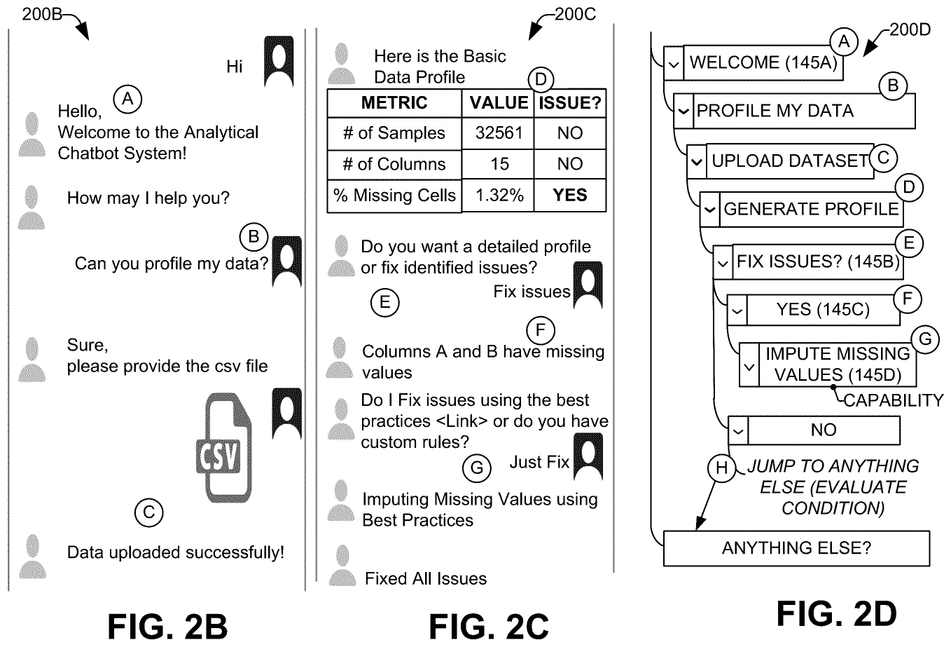

Dialogs, Dialog Trees, and Dialog Flows. Dialogs provide an interaction between an automated system (e.g., via a chatbot) and a user, wherein dialogs can be formed from respective statements representing an underlying functionality such as an API. FIG. 2A, dialog tree 200A (from dialog trees 200A-n) is presented herein to convey concepts and terms, whereby FIG. 2A can be read in conjunction with FIGS. 2B-D, as further described herein. In an embodiment, a capability can be incorporated into an API (e.g., per FIG. 1, capability 121A is incorporated into API 122A, capability 121B is incorporated into API 122B, capability 121n is incorporated into API 122n, and suchlike, as further described herein). Hence, as a user interacts with an automated system, e.g., via a chatbot, the user can be presented with dialogs 145A-n, as further described herein, (e.g., statements, prompts, questions, and suchlike) that, depending upon the user response (e.g., response dialog 145C to question dialog 145B), the automated system can determine if the user wishes to perform the function represented in the textual prompt (e.g., “upload a capability?”, “fix issues?), whereby the function can be execution of a capability 121A incorporated into the API 122A. Presentment of a series of dialogs 145A-n and their respective position (e.g., at any of nodes 210A-n) is referred to herein as a dialog flow occurring across a dialog tree, e.g., dialog tree 200A. Based on the respective responses, decisions, requests, etc., made by a user (e.g., via the chatbot), the dialog tree 200A can be navigated, wherein different dialogs 145A-n (and the respective APIs 122A-n and capabilities 121A-n they represent) can be combined (e.g., by the ACS) to form the dialog flow, wherein the respective dialogs 145A-n can be joined by connectors 220A-n, such that the respective responses can enable presentment of the corresponding dialog, e.g., dialog flow moves from node 210A “Question 1” to node 210B “Question 2” (via connector 220A), or node 210A “Question 1” to node 210C “Instruction” (via connector 220B), and suchlike. In an embodiment, the dialog tree 200A can be configured to pertain to a theme (e.g., in accordance with a task(s) to be performed by the end-user), subject matter, and suchlike. Hence, as part of incorporating an API 122A-n into a dialog tree 200A, the suitability of the API 122A-n regarding the theme of the dialog tree can be assessed (e.g., by the ACS) to ensure that the API 122A-n is pertinent to the theme, entities likely to be presented during a virtual conversation at a chatbot, a likely intent of a user when utilizing the chatbot, and suchlike.

Accordingly, a dialog flow can be created comprising of various dialogs comprising prompts, etc., wherein an API 122A-n can be respectively assigned to a prompt (at a node 210A-n with an assigned dialog 145A-n), with each respective API 122A-n having incorporated therein at least one capability 121A-n. Hence, as a user interacts with the automated interface, dialogs can be presented in response to a user's response/command, as well as the ACS guiding a user to a potentially pertinent capability 121A-n based upon presentment of a dialog 145A-n to which the capability has been associated with (e.g., via an API 122A-n). A dialog flow (as presented in FIGS. 2B-D) can represent the series of interactions and dialogs presented during user interaction with a chatbot, per dialog tree 200A.

Entities/Digital Entities are abstract representations of objects, subjects, concepts, etc. As well as providing information regarding an object, an entity can also convey how the data elements that form the information (attributes) relate to one another and how the information as a whole relates to a larger information environment. Digital entities can be used to represent digital objects in models (e.g., to which one or more dialogs, capabilities, or APIs can pertain), wherein the entities can be utilized by the ACS to map objects to a dialog (e.g., dialogs 145A-n) and further to the capability/API associated with the dialog.

Intent Classification and Entity Extraction. Briefly, the term intent is utilized herein to convey the determination (e.g., by ACS AI technology) of an intention(s) of a user wherein, the intent can be identified in an utterance made by the user when interacting with the chatbot. Further, the term entity relates to one or more modifiers/subjects pertaining to the intent of the utterance. Hence, where a user is not entirely clear regarding the intent of their interaction with a dataset, application of the various techniques available via NLU/NLP (described further below) can enable a dialog flow to quickly focus on an inference of the user's intent (e.g., based on the user's vocabulary, response to prompts in the dialog flow, identification of the user's intent, an entity the user mentions during the interaction with the chatbot, and suchlike). In an embodiment, by identifying a user's intent, selection of a dialog (e.g., dialogs 145A-n) relevant to the intent can be quickly achieved, thereby enabling a user to perform their intended task in an expeditious manner, further increasing user satisfaction in their chatbot experience.

Low-code and No-code relate to software development environments (e.g., in the visual domain via a graphical user interface (GUI)) enabling both experienced and inexperienced users to create software applications (e.g., a dialog tree(s) via drag and drop interaction and connection of software modules). Generally, low-code utilizes limited programming (e.g., by a data administrator) to combine/connect various blocks of code to form an overall desired task (e.g., interconnection of capabilities in a dialog tree). Further, no-code generally does not require the user (e.g., a data administrator) to have any coding experience whereby the user can select blocks of code/tasks they wish to combine and the underlying software automatically combines the blocks to create the overall desired task (e.g., interconnection of capabilities in a dialog flow/dialog tree).

Natural Language Processing (NLP) technology enables computers to understand human language in both written and verbal forms (e.g., in statements/utterances), and automatically implement AI technologies to perform tasks initiated by the utterances, etc., for example, uploading capabilities to the ACS and execution of APIs based on interaction at a chatbot. NLP can utilize machine learning and deep learning techniques to complete tasks, such as language translation or question answering (e.g., during navigation of a dialog tree). NLP can take unstructured data and convert it into a structured data format, e.g., via named entity recognition and identification of word patterns, using such methods as tokenization, stemming, lemmatization (e.g., root forms of words), and suchlike. A range of NLP algorithms exist, such as hidden Markov chains utilized for part-of-speech tagging, recurrent neural networks generating textual sequences, N-grams used to assign probabilities to sentences or phrases to predict an accuracy of a response, and suchlike. NLP techniques can be utilized in automated interfaces such as chatbots and speech recognition applications.

Natural Language Understanding (NLU) is a subfield of NLP, utilizing syntactic and semantic analysis of speech and text to determine the meaning of an utterance/sentence. Syntax refers to a grammatical structure of an utterance/sentence, while semantics pertain to the intended meaning of an utterance/meaning. NLU can also establish a data structure specifying relationships between words and phrases (e.g., ontology).

Slot filling generally describes identifying in a dialog and/or data structure, gaps/slots which correspond to different parameters, etc., of a user's query (e.g., currently being conducted at a chatbot), and which further, may be missing from the query and/or a dialog generated to be presented during an interaction. Hence, if a user submits a query that pertains to numerous options (e.g., data processing activities), the ACS (e.g., via the chatbot) can be configured to identify slots in the dialog for which further information can be sought and a respective capability/API can be identified based thereon (e.g., any of missing value identification, missing value imputation, class parity, etc.).

As used herein, data can comprise metadata. Further, ranges A-n are utilized herein to indicate a respective plurality of devices, components, signals etc., where n is any positive integer.

As mentioned, ACSs are available with a suite of capabilities and associated dialog-based conversation(s). Conventionally, the conversation dialogs are created, for example, by experienced data administrators or can be learned (e.g., by AI techniques) based on prior user interaction with a task (e.g., analysis of a dataset). The conversation dialogs trigger existing software capabilities (e.g., data profiling, value imputation, and suchlike) to be presented in an appropriate time/manner during a user conversation, e.g., as a dialog tree is navigated via a chatbot. ACSs can also be configured to enable a data administrator to onboard new capabilities regarding analysis, review, interaction, etc., e.g., for subsequent implementation with a dataset, for example, wherein the onboarded new capabilities can be incorporated into a dialog tree.

However, a key bottleneck with the currently available systems is the creation and presentation of meaningful and accurate dialogs on a GUI to enable new functionalities and capabilities to be easily and readily accessible/available to a user. An available capability may be highly relevant to an end-user's task, however, if the end user is unaware of the existence of the capability (e.g., it is not presented in a dialog by the ACS), it won't be utilized by the end-user. Hence, a situation can arise where a data administrator may have created a highly useful and functional capability at an ACS pertaining to an end-user's task(s), but if the capability is not presented to the end user, the end user is unaware of the existence of the capability and hence may deem the chatbot application to be of minimal use/pertinence to their data analysis needs.

Further, it can be highly complicated for a data administrator to integrate the new capability into an existing dialog tree(s) as, for example, a data administrator (i) tasked with creating the dialog flow has to be aware of all the existing dialog trees, and (ii) has to consider one or more correct places in an existing dialog tree where the functionality could be invoked, e.g., the point at which a functionality is presented has to be meaningful in terms of the task being/or to be performed (e.g., dataset being reviewed), and further, the sequence of activities being performed via the chatbot by the end-user. Hence, onboarding new capabilities in a conventional system driven by a data administrator is currently not scalable with regard to distributing and presenting new capabilities to an end-user in a meaningful and timely manner. The lack of scalability and the aforementioned problems with incorporating a new capability into an ACS can potentially hinder/prevent the evolution of data-related conversational systems, conversational AI platforms, chatbots, and suchlike.

Turning to FIGS. 2B-D, screens 200B and 200C present an example user interaction with an ACS to conduct missing value identification and imputation within a dataset, wherein FIGS. 2B-D can be read in conjunction with the dialog tree 200A presented in FIG. 2A. Screen 200B presents a first portion of an interaction, screen 200C presents a second portion of the interaction. The ACS can be configured to guide the interaction based upon user requests and functionality (e.g., capabilities) available at the ACS. The ACS can automatically call upon various APIs, and their associated capabilities, to perform various activities for the user, e.g., review and fix data. Schematic 200D is a dialog flow that occurred during the interaction between an end-user and a user interface, per screens 200B and 200C. As shown, the dialog tree 200A can be configured to present various dialogs 145A-n to a user, wherein, some dialogs may be configured to ask a question (e.g., to determine an intent(s) of a user), while other dialogs can be configured to execute an API 122A-n and an associated capability 121A-n (as further described herein).

Stepping through the various stages and activities/operations presented in FIGS. 2B-2D, at (A), in an example embodiment, when a user (i) uploads a new dataset (presented here as a .csv file) or (ii) points to an existing dataset, an ACS can be configured to automatically initiate a conversation dialog 145A in response to the user interaction. As shown at (B), the user can request the ACS to profile the dataset and raise any concerns regarding the structure, integrity, etc., of the dataset. At (C), the dataset is uploaded. It is to be appreciated that while FIG. 2B illustrates a data file being uploaded, the interaction between the user and the user interface can be in a question format as well, wherein AI at the ACS can review data/file/information as it is being uploaded/entered and make a determination that the user has provided all the data, etc., as required by the ACS to subsequently create a dialog and incorporate the dialog into a dialog tree.

Continuing the example, at (D) the ACS can be configured to review the dataset (e.g., by an API 122A-n having an associated capability 121A-n configured to review data) and provide a Basic Data Profile indicating the number of samples, number of columns, percentage of missing cells, and suchlike. At (E), a dialog 145B can be presented to determine whether the user wishes (dialog 145C, “yes”) to receive a more detailed profile of the data (e.g., by an API having an associated capability configured to provide greater review) or have the identified issues fixed (e.g., by an API having an associated capability configured to fix the identified issues). At (F), the ACS can present a dialog identifying the respective issues (e.g., columns A and B have missing values) and further determine whether the user requires the issues to be fixed. At (G), in response to an entry of “YES/Just Fix”, the dialog flow can advance to an operation imputing the missing values (e.g., by an API 122A having an associated capability 121A to impute missing values based on other values in the dataset), e.g., per dialog 145D. In the event of the user only requires the data to be fixed, the interaction between the user and the ACS can terminate (e.g., at node 210D of FIG. 2). Alternatively, returning to (E), in the event of the user does not request the missing values be imputed, the dialog flow can advance to (H) with a programmed jump to an “Anything Else/Evaluate Condition” dialog, wherein the dialog flow can proceed from there in accordance with the programmed dialogs in the dialog tree, per FIG. 2A. The respective flow and decision points can be represented as nodes 210A-n on a dialog tree 200A, wherein the nodes can be joined by connectors 220A-n.

The various embodiments presented herein enable users (e.g., data administrators) to onboard a new capability (e.g., in the form of an API) to an ACS, wherein the ACS is configured to automatically identify a location in a dialog tree for a user to interact with the capability and can further auto-generate any required dialog (e.g., a natural language dialog) to present the capability to the user. Hence, upon submission of a capability to the ACS, the ACS can identify parameters, features, etc., of the capability, generate one or more dialogs based on the capability parameters, features, etc., and further incorporate the dialog(s) into a dialog tree to enable an end-user to perform respective actions (e.g., data analysis) via a front-end system (e.g., a user interface, a chatbot, etc.) available at the ACS. The various embodiments presented herein facilitate construction and deployment of an ACS configured to perform any of the following activities:
1. [ANALYSE] Analyse metadata and information associated with the ingested capability 121A-n to identify entities, intents, parameters, attributes, functionality, slots, etc., where the parameters, etc., can be utilized to generate a dialog 145 A-n pertaining to the capability 121A-n.
2. [ADD] a new dialog 145 A-n can be generated to access the new capability 121A-n independently. A new dialog can be generated, for example, when there are no currently existing capabilities relating to, for example, functionality provided by the newly created capability (e.g., 121A-n) (or its associated API 122A-n).
3. [INHERIT] identify already existing capabilities 123A-n that are similar to the newly created capability 121A-n, clone an existing dialog 146A-n that is associated with the identified similar capabilities, and update the existing dialog 146A-n to accept, from an end-user, the required parameters pertaining to the new capability 121A-n.
4. [UPDATE] Analyse and alter existing dialog tree 200A-n to enable end-users to implement the added features in a relevant manner, e.g., the ACS generates a dialog based on the new capability and further inserts the dialog into an already existing dialog tree (e.g., at a node that the ACS deems to be relevant to the new dialog and associated capability. In an embodiment, in response to user inputs (e.g., by a data administrator), the ACS can either add the new capability alongside the existing capability or replace the current capability.
   4.1. [CONFIRM] Prior to implementing a dialog (and associated capability/API) the ACS can indicate to a user (e.g., a data administrator) where the ACS recommends the dialog to be implemented in a dialog tree 200A, wherein the user can accept or cancel the recommendation. In response to the recommendation being cancelled, the ACS can provide other dialog implementations for acceptance. Alternatively, the relationship between the capability 121A-n and the dialog tree 200A can be reviewed to determine whether the capability 121A-n can be incorporated at a more suitable location/node 210A-n.
5. [FEEDBACK] feedback can be collected regarding how successfully a dialog flow (that includes the new capability 121A-n) enabled an end user to achieve their task (e.g., data analysis). The feedback enables remediation of any inaccuracies that may be present in a dialog tree 200A resulting from inaccurate/faulty updating of a dialog tree due to incorrect incorporation of the new capability (e.g., the new capability does not pertain to a focus of the existing data tree).
   5.1. [ROLL BACK TO A PRIOR CONFIGURATION] Further, in response to user feedback indicating a lack of success in incorporating the dialog (and new capability 121A-n) into a dialog tree 200A, the ACS can be further configured to undo the various changes conducted to a previously existing dialog tree, and reset/roll back the amendments to return to the configuration of the dialog tree prior to the new dialog 145A-n being incorporated therein.
6. [SECURITY] authentication of a user can be required to onboard a new capability and associated API.
   6.1. a system can be developed such that only owners of a particular toolkit and/or collection of APIs, or a select subset of users with specific roles (e.g., authorized data administrators) are only authorized to initiate the ACS in adding new features (e.g., a new capability 121A-n) to an existing dialog tree and/or create a new dialog.
   6.2. implementation of user authentication and authorization enables restriction of an uncontrolled evolution of the backbone dialog trees. Accordingly, only capabilities that are meaningful/pertain to an existing dialog flow(s) can be added to the existing dialog tree 200A.

The various embodiments presented herein enable handling of a new API for which a user chat conversation is not available, as well as updating a currently existing API in accordance with a new API configuration. Further, existing dialog trees and flows can be inherited by an ACS and automatically adapted by the ACS to create new dialog(s) and dialog flow(s) for the onboarded configurations/APIs. Hence, the ACS can be configured to automatically update existing dialog trees (e.g., in accordance with received capabilities) to automatically include the new APIs into the existing dialog tree. In another embodiment, the ACS can be further configured to identify the intents, entities, parameters, etc., for a capability/API (e.g., in metadata of the API) and (i) generate applicable dialogs therefrom, as well as (ii) use the metadata, etc., to identify a suitable location in a dialog tree at which to incorporate the API.

It is to be appreciated that numerous approaches are available for incorporating new/updated capabilities and APIs into a dialog tree such that the new capabilities, etc., are presented in a meaningful manner during a chatbot interaction. Various embodiments are presented herein, and while the following approaches are described regarding incorporating a new and/or updated capability into a dialog, the embodiments are non-limiting and any combination of approaches for automated incorporation of a capability into a dialog tree and subsequent triggering of execution of an associated API in a dialog flow are envisaged.
1. CLONE AN EXISTING DIALOG.
2. UPDATE AN EXISTING DIALOG BY APPENDING A NEW CAPABILITY THERETO.
3. UPDATE AN EXISTING DIALOG BASED UPON SUGGESTIONS AND FEEDBACK.
4. UPDATE AN EXISTING DIALOG BY REPLACING A CURRENTLY AVAILABLE CAPABILITY WITH AN UPDATED VERSION OF THE CAPABILITY.

FIG. 1 illustrates an ACS 100 comprising an analytical chatbot system architecture to facilitate incorporation of various capabilities into, and presentment with, a chatbot application, in accordance with one or more embodiments. ACS 100 comprises an API dialog generator 105 which is communicatively coupled to a capability/API generator component (CAPI component) 120, and further communicatively coupled to a user-API interaction system 160, wherein the user-API interaction system 160 can be further communicatively coupled to a front-end system 161 (e.g., a user interface, a chatbot, and suchlike). In an embodiment, a first user U1 (e.g., a data administrator) can interact with the CAPI component 120 to generate/upload one or more capabilities 121A-n. As further described, the respective capabilities 121A-n can be received by the API dialog generator 105 for respective processing for automated incorporation into a dialog-driven interaction(s). Various outputs (e.g., capabilities 121A-n APIs 122A-n, dialogs 145A-n) from the API dialog generator 105 can be transmitted to the user-API interaction system 160 for incorporation into a dialog interaction with a user (e.g., user U2, an end-user), e.g., such as via a dialog tree 200A.

With reference to FIG. 1, providing a general overview of the respective operations performed at the ACS 100:

At (1) a user U1 can utilize the CAPI component 120 to incorporate/configure/generate one or more capabilities 121A-n, wherein respective APIs 122A-n can be generated for one or more of the capabilities 121A-n.

At (2) The API dialog generator 105 can be configured to receive the capabilities 121A-n/APIs 122A-n and, as further described, be further configured to generate dialogs 145A-n pertaining to the capabilities 121A-n/APIs 122A-n (e.g., based on one or more features of the capabilities 121A-n/APIs 122A-n).

At (3) The respective dialogs 145A-n, capabilities 121A-n, APIs 122A-n and any associated parameters, metadata, etc., can be forwarded to the user-API interaction system 160, for, at (4), incorporation into one or more dialog trees (e.g., dialog tree 200A).

At (5), presentment of the respective dialogs 145A-n can be based upon an interaction between a user (e.g., user U2) and a user interface, front-end system 161 (e.g., a chatbot or similar interface).

As shown, API dialog generator 105 can comprise a user authentication component 130. As previously mentioned, authentication/authorization of a user (e.g., user U1) can be performed before a new capability 121A-n (e.g., contained in an API) is onboarded at the API dialog generator 105. The authentication component 130 can be configured to ensure that only owners of a particular toolkit and/or collection of APIs, or a select subset of users with specific roles (e.g., authorised data administrators) are able to add new features (e.g., a new capability) to an existing dialog tree (e.g., dialog tree 200A-n) and/or create a new dialog (e.g., dialog 145A-n). The authentication component 130 can prevent uncontrolled evolution of the backbone dialog trees 200A-n, and accordingly, only capabilities that are meaningful/pertain to an existing dialog tree can be added.

As further described, generation of any of the new capabilities 121A-n, new APIs 122A-n, dialogs 145A-n (e.g., as generated from new capabilities 121A-n and new APIs 122A-n), and any parameters, features, etc., (e.g., in the form of metadata) pertaining thereto, can be respectively based on comparisons with and/or the existence of pre-existing (aka original) capabilities 123A-n, APIs 124A-n, dialogs 146A-n (e.g., as generated from the pre-existing capabilities 123A-n and APIs 124A-n).

The API dialog generator 105 can include an API analyzer 134, wherein the API analyzer 134 can be configured to compare/analyze any of the capabilities 121A-n, APIs 122A-n, dialogs 145A-n, and any features, etc., (e.g., in the form of metadata) pertaining thereto, with the pre-existing capabilities 123A-n, APIs 124A-n, dialogs 146A-n, and any features, etc., (e.g., in the form of metadata) pertaining thereto.

The API dialog generator 105 can further include a similarity detection component 138 configured to determine whether any capabilities 121A-n are similar to capabilities 123A-n, whether any APIs 122A-n are similar to APIs 124A-n, and whether any dialogs 145A-n are similar to dialogs 146A-n. The similarities can be determined based on any suitable criteria, such as similar functionality, parameters, features, metadata, and suchlike.

The API dialog generator 105 can further comprise a clone dialog component 140, wherein the clone dialog component 140 can be configured to, in the event of a determination (e.g., by similarity detection component 138) that no APIs 122A-n are similar to any of APIS 124A-n, generate a standard dialog 145A-n. The clone dialog component 140 can be configured to generate the standard dialog 145A-n from a dialog template, wherein the standard dialog 145A-n can be subsequently configured with functionality in accordance with the API 122A-n/capability 121A-n to be utilized. In another embodiment, the clone dialog component 140 can be configured to clone a dialog 145A-n for an API 122A-n based on a pre-existing dialog 146A-n created for an API 124A-n having functionality most similar to the API 122A-n, e.g., as determined by the similarity detection component 138, as previously described. In a further embodiment, the clone dialog component 140 can be further configured to perform a slot filling function during creation of a dialog 145A-n, wherein, as part of the creation of the dialog 145A-n (e.g., for an API 122A-n), the clone dialog component 140 can determine that there is insufficient information currently available regarding either of API 122A-n and/or capability 121A-n for the dialog 145A-n to be generated with the necessary level of functionality. Accordingly, the clone dialog component 140 can generate a notification to a user (e.g., user U1) informing them of the slots/gaps in the information regarding API 122A-n and/or capability 121A-n, such that, for example, the clone dialog component 140 will not be able to determine a user intent which applies to the dialog 145A-n currently being generated, or the clone dialog component 140 is unable to determine one or more entities to which the dialog 145A-n will pertain to, and suchlike. The gaps in the information can be considered to be slots, whereby, in response to the notification regarding the gaps, the user can provide the required information, which the clone dialog component 140 can subsequently apply to the dialog 145A-n to fill the one or more slots. The notification and subsequent interaction during the slot filling activity can be performed at the CAPI component 120 in an ask/response manner where the user can provide the necessary information until the slots have been filled by the clone dialog component 140. Upon completion of the slot filling operation, the dialog 145A-n can be generated by the clone dialog component 140 for subsequent incorporation into a dialog tree 200A. In an alternative embodiment, the clone dialog component 140 can identify one or more slots in a dialog which can be utilized to gather information during an interaction with an end-user U2. Accordingly, the one or more slots can be utilized to identify an entity of interest or an intent of the end-user U2 when interacting with the ACS. In a further embodiment, the clone dialog component 140 can instantiate/create unique dialogs 145A-n that can be initially constructed based on the aforementioned dialog inheritance operation, but which can be further supplemented based on information provided by a user, e.g., as previously described regarding the slot filling activity.

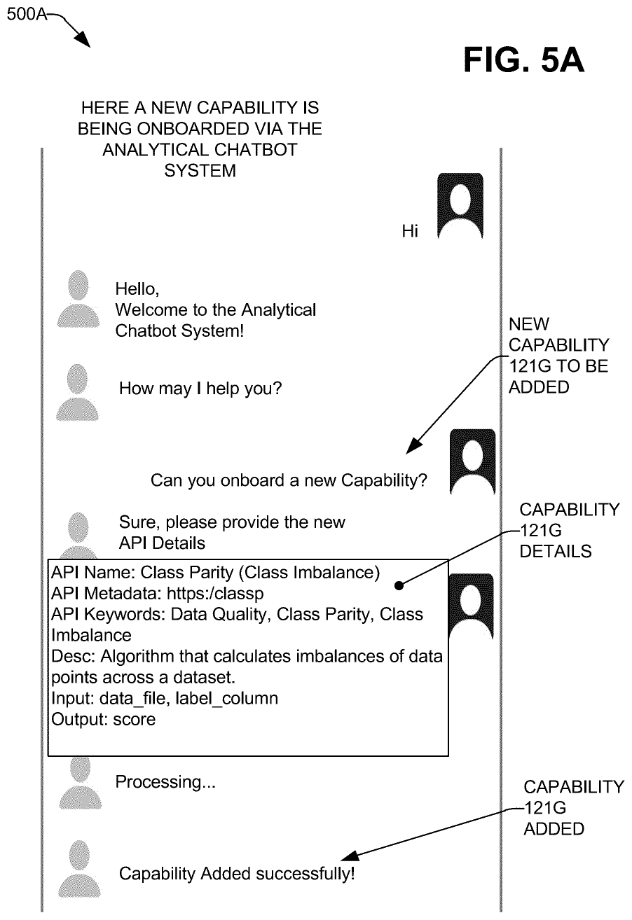

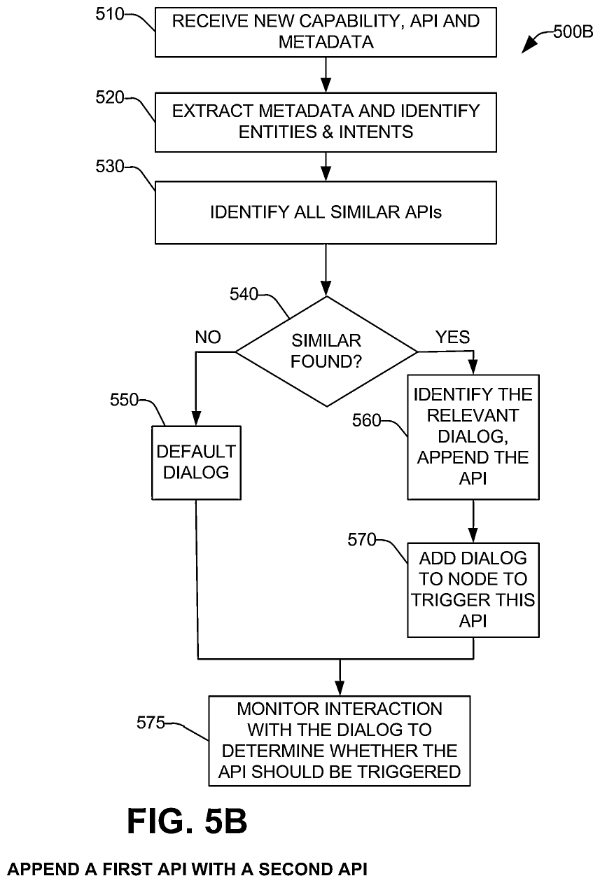

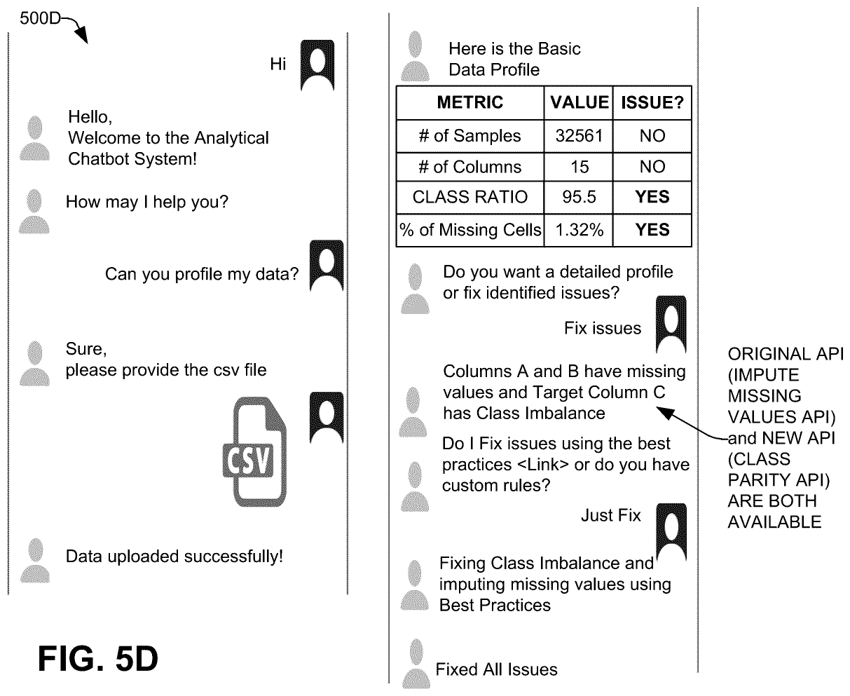

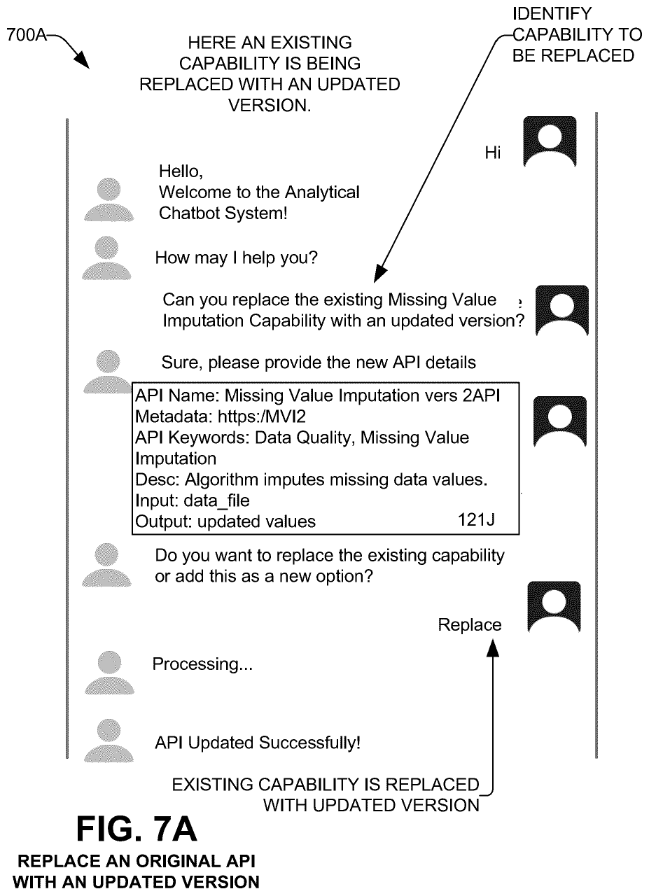

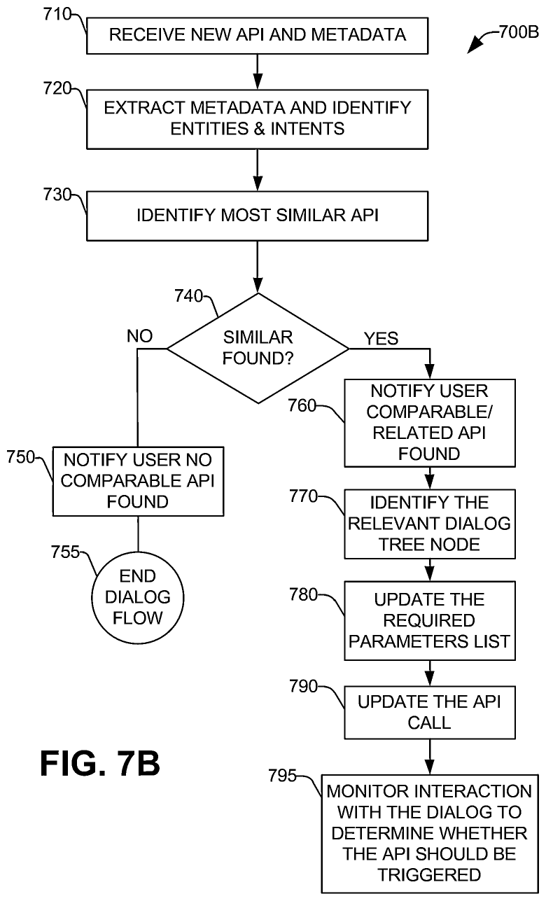

The API dialog generator 105 can further comprise an update dialog component 150, wherein the update dialog component 150 can be configured to append a current dialog 146A-n which includes functionality pertaining to an API 124A-n with an API 122A-n such that the appended dialog 146A-n comprises functionality for both an API 124A-n and an API 122A-n (as further described in FIGS. 5A-D). In another embodiment, the update dialog component 150 can be configured to perform a replace function, such that a dialog 146A-n includes functionality for a pre-existing API 124A-n, whereby a user (e.g., user U1) can be notified that API 124A-n includes functionality similar to an API 122A-n currently being generated by the user, and the user can make a determination as to whether they wish to replace the pre-existing API 124A-n with the updated functionality of API 122A-n (e.g. as further described in FIGS. 7A-D). As further described, the update dialog component 150 can be further configured to identify one or more nodes 210A-n in a dialog tree 200A to determine at least one point to include/inject/locate any of the dialogs 145A-n, such that as a user (e.g., user U2) engages in a dialog flow with ACS 100, the respective dialog 145A-n is presented at the appropriate time/point in the dialog tree 200A such that the respective dialog 145A-n presented pertains to a task the user wishes to undertake. Accordingly, a trigger can be incorporated into the respective dialog 145A-n associated with a node 210A-n, such that when a particular response/information is provided by the user, the trigger in the dialog 145A-n causes the associated API 122A-n to be initiated.

The update dialog component 150 can be further configured to perform a slot filling operation (e.g., similar to the slot filling operation performed by clone dialog component 140), to facilitate an appended dialog 146A-n or a dialog 146A-n which has had functionality of an API 124A-n to be replaced with functionality of an API 122A-n, such that the update dialog component 150 can obtain further information to slot into the functionality of API 122A-n, e.g., where API 122A-n is being appended to functionality of an API 124A-n or replacing functionality of an API 124A-n. As previously described, the slot filling operation can be performed by the update dialog component 150 in response to information provided by a user U1, for example.

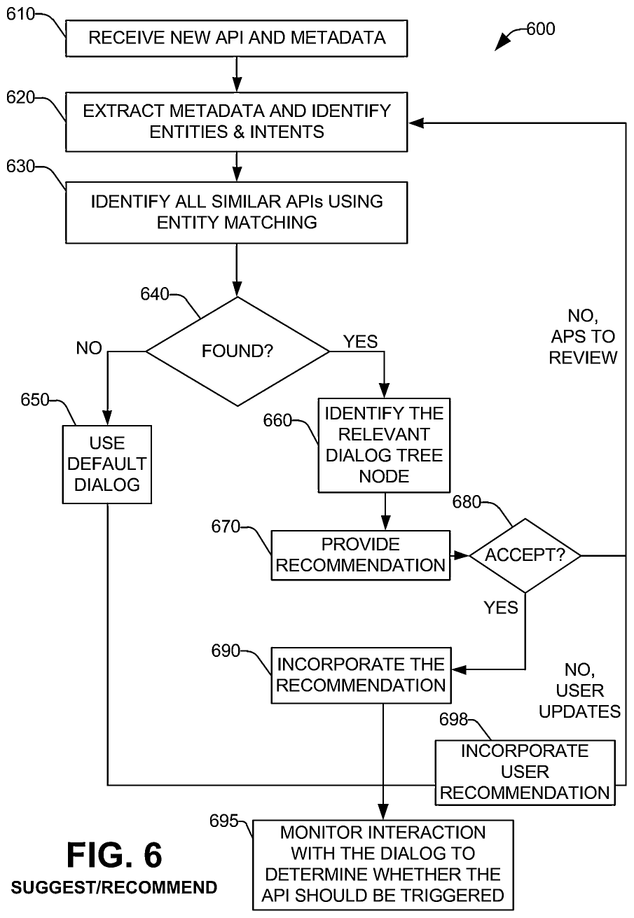

In a further embodiment, the update dialog component 150 can be configured with a dialog suggestion operation, wherein the update dialog component 150 can recommend one or more features regarding a dialog 146A-n that is currently being constructed by the API dialog generator 105, such that finalization of the dialog 146A-n does not occur until the user U1 has authorized/confirmed the features recommended by the update dialog component 150 are to be used/triggered in the creation of the dialog 146A-n (e.g., as further described in FIG. 6).

Accordingly, the update dialog component 150 can be further configured to automatically identify all APIs 124A-n similar to an API 122A-n being constructed, automatically identify a dialog 146A-n that pertains to the similar API 124A-n, automatically adjust the functionality of the dialog 146A-n to support the API 122A-n of interest, automatically identify an injection point/node 210A-n (e.g., based on entity, intent, theme, and suchlike) at which to incorporate the updated dialog 146A-n (or a dialog 145A-n generated therefrom) into dialog tree 200A, generate an API trigger for the injection point/node 210A or dialog 145A/n or 146A-n, and further enable the foregoing to be presented on a front-end system 161 to a user U2.

Further, API dialog generator 105 can include a feedback component 155 configured to receive feedback (e.g., from user U2) regarding such information as a suitability of the capability 121A-n for a review of a dataset 189A-n being conducted, accuracy of the capability 121A-n in achieving a user requirement regarding interaction with the dataset 189A-n, and suchlike. In another embodiment, the feedback component 155 can also receive feedback from user U1 indicating whether a dialog 145A-n and/or a point of insertion into a dialog tree 200A were correctly performed by the ACS 100 or whether the automated process(es) should be amended further to correctly generate and/or insert the dialog 145A-n.

It is to be appreciated that while FIG. 1 presents certain functionality being performed by one component, the functionality can be performed by an of the respective components in ACS 100, as well as two or more components operating in conjunction with each other. Accordingly, for example, the clone dialog component 140 and/or the update dialog component 150 can utilize NLU/NLP functionality represented in FIG. 1 as being performed by an NLU/NLP engine 170. Thus, the respective components comprising ACS 100 can operate in a cross-platform manner.

As further shown, user-API interaction system 160 can include a NLU/NLP engine 170, a dialog management system 172, an orchestration layer component 174, a data processing module 179, an API hub (public/private) 180, a logging component 182, a quality assurance and enhancements component 184, a monitoring and reporting dashboards & insights component 185, a data “extract, transform, load” (ETL) component 186, and, as previously mentioned, raw data 188.

The NLU/NLP engine 170 can utilize respective language processing techniques (as previously mentioned) to enable ACS 100 to understand interactions (e.g., utterances, text entries) occurring between a respective user U1 and CAPI component 120, and user U2 at front-end system 161. Further, the NLU/NLP engine 170 can include technology (e.g., Al processes, and suchlike) pertaining to intent classification and entity extraction, as previously mentioned. Further, NLU/NLP engine 170 can provide text/utterances to the API dialog generator 105 to enable dialogs 145A-n to be created that have language understandable to the end-user U2 during their interaction with the dialogs 145A-n and dialog tree 200A.

The dialog management system (DMS) 172 can be configured to control state and flow of an interaction/conversation between the end-user U2 and the ACS 100. The responses/utterances of the end-user U2 can be an input to the DMS 172, while outputs from the DMS 172 can be implementation of respective dialogs 145A-n/146A-n as the conversation navigates the dialog tree 200A. DMS 172 can also be configured to maintain a dialog history, questions remaining to be answered by the end-user U2, etc. DMS 172 can utilize the NLU/NLP engine 170 to assist in understanding the response(s) from either of users U1 and U2 to enable the next dialog 145A-n/146A-n to be presented.

The orchestration layer component 174 can be configured to manage and/or monitor interactions across the ACS 100, e.g., between the front-end system 161 and the respective components included in the user-API interaction system 160 and the API dialog generator 105. Such interactions can pertain to either of user U1 and/or user U2 interacting with the ACS 100, wherein the orchestration layer component 174 can monitor/control activity occurring at a node (e.g., any node 210A-n), activity due to a dialog (e.g., any dialogs 145A-n, 146A-n) being associated/assigned to a node, activity occurring at the node/dialog (e.g., data entry, commands, etc.), activity occurring from attachment of a capability (e.g., any of capabilities 121A-n, 123A-n) and/or an API (e.g., any of APIs 122A-n, 124A-n) to a node, activity resulting from incorporation of a capability and/or an API into a dialog, data (e.g., entity, intent, parameter data, saved as data 188), interaction activity with a dataset (e.g., dataset 189A-n), and suchlike.

The data processing module 179 can be configured to review and process data/information entered/created/generated during activity occurring across the ACS 100, wherein the data processing module 179 can process data and associated activity occurring at a node (e.g., any node 210A-n), data arising from a dialog (e.g., any dialogs 145A-n, 146A-n) being associated/assigned to a node, data generated at a node/dialog (e.g., data entry, commands, etc.), data generated due to attachment of a capability (e.g., any of capabilities 121A-n, 123A-n) and/or an API (e.g., any of APIs 122A-n, 124A-n) to a node, data arising from incorporation of a capability and/or an API into a dialog, data arising from interaction with a dataset (e.g., dataset 189A-n), and suchlike.

The API hub 180 can be utilized to store the various APIs 122A-n and 124A-n utilized by the ACS 100, acting as a central repository which can be accessed by any of the API analyzer 134, the similarity detection component 138, the clone dialog component 140, the update dialog component 150, etc., in ACS 100. Hence, information regarding the APIs, their associated capabilities 121A-n/123A-n, dialogs 145A-n/146A-n, parameters, metadata, etc., can be stored and accessed as needed during the automated construction/implementation of the dialogs 145A-n.

The logging component 182 can be configured to monitor and log the interactions between the end-user U2 and the dialogs 145A-n/146A-n, such that any logged information can be utilized to assist the ACS 100 in generating dialogs 145A-n in the future.

The quality assurance and enhancements component (QAE) 184 can be configured improve the dialogs 145A-n and their presentment in the dialog tree 200A, e.g., based upon any of information/logs received from the logging component 182, debugging the dialogs 145A-n, retraining the ACS 100 regarding generating useful dialogs 145A-n, user feedback analysis, etc. Information gathered and determinations made thereon by the QAE component 184 can be provided to the feedback component 155.

The monitoring and reporting dashboards & insights component 185 comprises a collection of metric groups or custom views that can be utilized to monitor the performance of the ACS 100.

The data ETL component 186 component can be configured to perform a data integration process that combines data from multiple data sources, such that the ETL process can assist in gathering information that can be utilized to generate any of capabilities 121A-n, APIs 122A-n, dialogs 145A-n, (and any of the pre-existing capabilities 123A-n, APIs 124A-n, and dialogs 146A-n) as required to enable a dialog tree 200A and associated dialog flow to occur whereby the respective dialogs 145A-n are correctly and meaningfully located in the dialog tree 200A. In an embodiment, data 188 can comprise data implemented/extracted by the data ETL component 186, e.g., metadata, parameters, etc., pertaining to any of the capabilities 121A-n/123A-n, APIs 122A-n/124A-n, dialogs 145A-n/146A-n, etc.

As shown in FIG. 1, the API dialog generator 105 and the user-API interaction system 160 can include respective processors 112 and 162, and further, respective memories 114 and 164, wherein the processors 112 and 162 can execute the various computer-executable components, functions, operations, etc., presented herein. The memories 114 and 164 can be utilized to store the various computer-executable components, functions, code, etc., as well as capabilities 121A-n and 123A-n, APIs 122A-n and 124A-n, dialogs 145A-n and 146A-n, data ETL component 186, raw data 188, dialog tree 200A, nodes 210A-n, feedback information (e.g., by feedback component 155), dialog recommendations, entities, intents, parameters, features, metadata, and suchlike pertaining to any of the objects, components, etc., described herein.

As further shown, the API dialog generator 105 can include an input/output (I/O) component 116, wherein the I/O component 116 can be a transceiver configured to enable transmission/receipt of information (e.g., capabilities 121A-n and 123A-n, APIs 122A-n and 124A-n, dialogs 145A-n and 146A-n, data ETL component 186, raw data 188, dialog tree 200A, nodes 210A-n, feedback information (e.g., by feedback component 155), dialog recommendations, entities, intents, parameters, features, metadata, and suchlike pertaining to any of the objects, components, etc., described herein) between the ACS 100 and any external system(s) 199. Transmission of data and information between the ACS 100 (e.g., via antenna 117 and I/O component 116) and the remotely located devices and systems 199 can be via the signals 190A-n. Any suitable technology can be utilized to enable the various embodiments presented herein, regarding transmission and receiving of signals 190A-n. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like. Alternatively, the external system 199 can be communicatively coupled within the same system, e.g., comprise respective components in a computer system.

In an embodiment, the ACS 100 can further include one or more human-machine interfaces 118/168 (HMI) (e.g., a display, a graphical-user interface (GUI)) which can be configured to present various information including the capabilities 121A-n and 123A-n, APIs 122A-n and 124A-n, dialogs 145A-n and 146A-n, data ETL component 186, raw data 188, dialog tree 200A, nodes 210A-n, feedback information (e.g., by feedback component 155), dialog recommendations, entities, intents, parameters, features, metadata, and suchlike pertaining to any of the objects, components, etc., per the various embodiments presented herein. The HMI 118/168 can include an interactive display to present the various information via various screens 119A-n and/or 169A-n presented thereon, and further configured to facilitate input of information/settings/etc., regarding the various embodiments presented herein regarding operation of the ACS 100.

While not shown in FIG. 1, it is to be appreciated that CAPI component 120 and user-API interaction system 160 can also have incorporated therein any necessary processors, memory, HMI's, screens, I/O devices, antenna, etc., to facilitate display, transmission and receipt of information, and suchlike, operating in a manner comparable to any of processor 112, memory 114, HMI 118, screens 119A-n, I/O device 116, antenna 117, signals 190A-n, information 198, and suchlike.

Any suitable software can be utilized across the ACS 100 and operations performed thereon, e.g., live chat software, help desk software, contact center software, NLU software, NLP software, database management software, open-standard file format (e.g., JSON), licensed software, query language, and suchlike. For example, capabilities 121A-n can be uploaded (e.g., via CAPI component 120) to the ACS 100 using any suitable file format, for example a JSON file, wherein the input data can be transformed to a second format suitable for analyzing the content and generating dialog(s) 145A-n, based thereon. Accordingly, the CAPI component 120 and the front-end system 161 can be configured to operate as a virtual agent, as a virtual assistant, as an external system (e.g., a customer facing system), as an internal system (e.g., an employee facing system), etc. Further, the CAPI component 120 and front-end system 161 can be respectively located local to the ACS 100 or remotely located (e.g., via internet, the “cloud”, and suchlike.

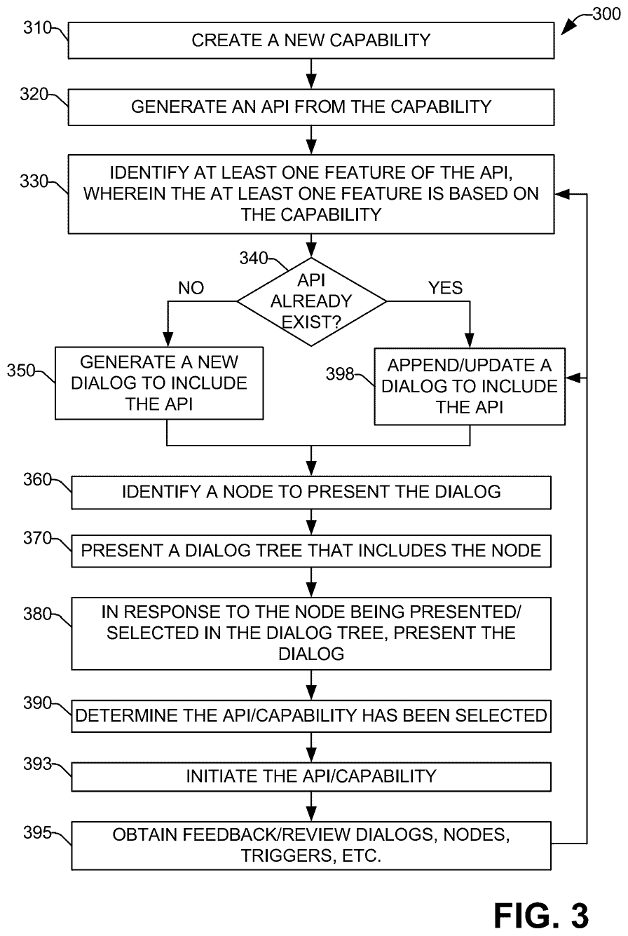

FIG. 3 presents a computer-implemented methodology 300 for generating a capability, incorporating the capability into an API, and further presenting the capability during interaction with a dataset by a user, in accordance with one or more embodiments.

At 310, the computer-implemented method can comprise a user (e.g., user U1, a data administrator) generating a new capability (e.g., capability 121A-n, a first capability), wherein the new capability can be subsequently utilized, for example, in analyzing a dataset.

At 320, in an embodiment, the new capability can be incorporated into an API (e.g., new API 122A-n, a first API) (e.g., at the CAPI component 120). The new API can have a format such that the new API can be subsequently incorporated into a dialog tree (e.g., dialog tree 200A-n and associated dialog flow) presented during an interactive chat session on a chatbot (e.g., on front-end system 161) as an end-user (e.g., user U2) interacts with the chatbot (and underlying ACS 100). As previously mentioned, numerous approaches are available to incorporate the new capability that is available to be executed as part of a dialog between a chatbot AI system and a user (e.g., user U2) analyzing a dataset.

At 330, various features, properties, parameters, functionality, etc., pertaining to the capability can be utilized to provide according features, properties, parameters, functionality, etc., to the new API. The features, etc., can be imparted to the new API in the form of metadata. The properties can include one or more entities, one or more intents, etc., to which the capability pertains.

At 340, a determination (e.g., by any of similarity detection component 138, clone dialog component 140, update dialog component 150) can be made regarding whether an already existing API (e.g., API 124A-n) has similar functionality, etc., to the new API (e.g., API 122A-n). The determination can be made, for example, by reviewing the metadata of the new API and metadata associated with the already existing APIs. Analysis at 340 can be utilized to determine whether a new dialog (e.g., dialog 145A-n) is to be created for the new API, or a currently existing dialog (e.g., dialog 146A-n) is to be appended, updated, transformed, to include the new API. In response to “NO, an API does not already exist having the functionality of the new API”, methodology 300 can advance to 350, wherein a new dialog can be created that captures the required functionality of the new API and associated capability.

The flow can advance to 360, wherein a node (e.g., node 210A-n) in a dialog tree (e.g., dialog tree 200A) can be identified (e.g., by any of similarity detection component 138, clone dialog component 140, update dialog component 150) to present the new dialog. For example, the node can be identified based on the metadata defined for the new API. As previously mentioned, interaction by a user (e.g., user U2) with the dialog tree can trigger presentment/activation of the new API.

At 370, a dialog tree (e.g., dialog tree 200A) can form the backbone of interaction between a user (e.g., user U2) and the ACS. As the user interacts with the ACS (e.g., via a chatbot, front-end system 161), the dialog tree can be navigated by the ACS (e.g., via the dialog management system 172) with the respective dialogs (e.g., dialogs 145A-n) being presented as nodes/decision points (e.g., nodes 210A-n are interacted with), wherein the dialog flow can be presented in accordance with navigating the dialog tree and the respective nodes (and associated dialogs).

At 380, a determination can be made (e.g., via the dialog management system 172) that given a user is interacting with a node, the associated dialog can be presented on the chatbot screen (e.g., screen 119A-n), e.g., based upon a user responding to a question presented by the chatbot.

At 390, a determination can be made (e.g., via the dialog management system 172) as to whether the user response/interaction with the dialog (and information presented thereon) causes the API and associated capability to have been selected (e.g., FIG. 2a, dialogs 145B and 145C interactions).

At 393, in response to determining (e.g., via the dialog management system 172) the user response with the dialog requires initiation of the API/capability, the API and/or the capability can be executed, e.g., the capability and/or the API performs a function on the dataset 189A-n being reviewed by the user.

At 395, feedback can be obtained (e.g., by a chatbot user, by an automated process conducted by the QAE component 184, the feedback component 155, and suchlike) regarding the applicability of the API/capability being presented at a given node/dialog in the dialog tree in accordance with the intent of the user U2. In response to a determination that the capability was incorrectly activated, dialog was poorly formed/worded, methodology 300 can return to 398, wherein a review of the API and the dialog it is associated with can be conducted. For example, the API can be removed from the dialog, the dialog can be updated to more accurately represent the API, and suchlike.

As shown, methodology 300 can further return to 330, such that, in another example, the API can be reviewed (e.g., by QAE component 184, the feedback component 155, etc.), e.g., the features, parameters, etc., defined for the capability in the metadata applied to the API can be reviewed for accuracy, and if necessary, replaced, for example, in response to further information/metadata being provided to the ACS regarding any of the API, the capability, the dialog, etc. It is to be appreciated that the foregoing examples are non-limiting and any suitable technique can be utilized to correct an API/capability for being incorrectly invoked (e.g., due to the API/capability not being correctly associated with a triggering node/node, ill-defined functionality of the API/capability, and suchlike).

Returning to step 340, in response to a determination that an API (e.g., API 124A-n) already exists that has functionality similar to the new API (e.g., API 122A-n), the dialog (e.g., dialog 146A-n) associated with the existing API can be identified. As further described, the existing API in the dialog can be replaced with the new API, alternatively, the new API can be appended such that the existing dialog includes functionality pertaining to both the existing API and the new API. The methodology 300 can subsequently advance to step 360, as previously described.

### 1. Cloning an Existing Dialog

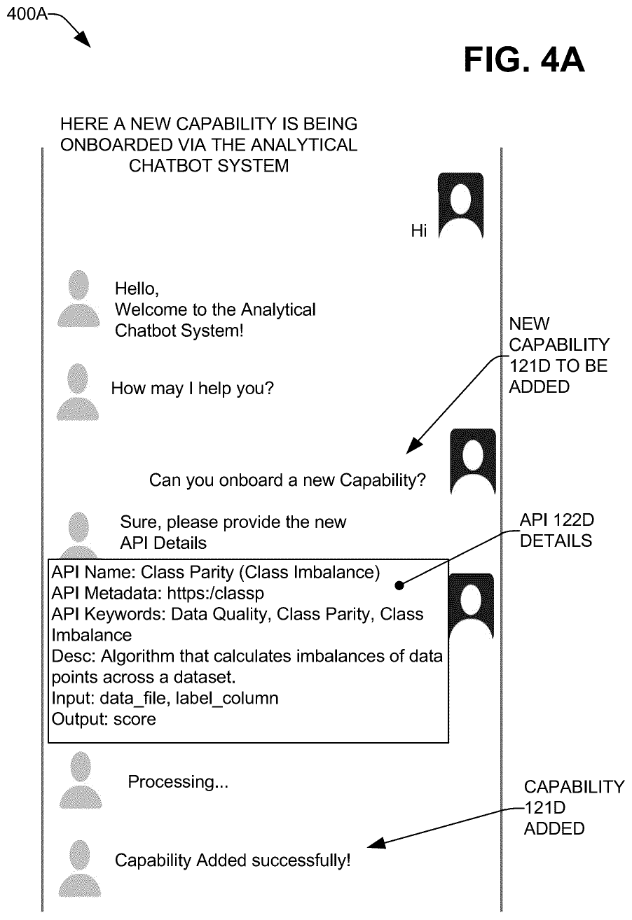

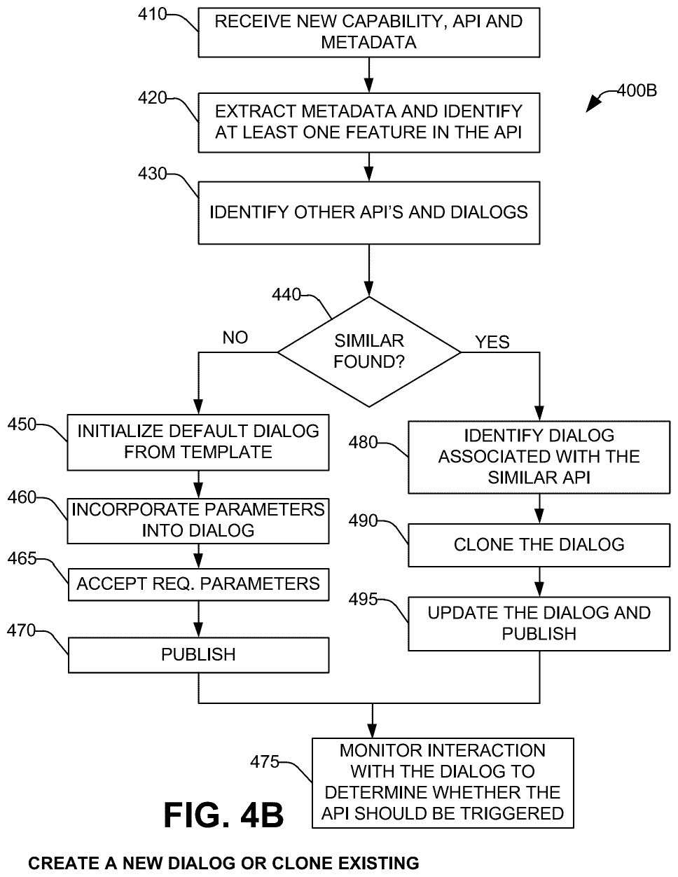

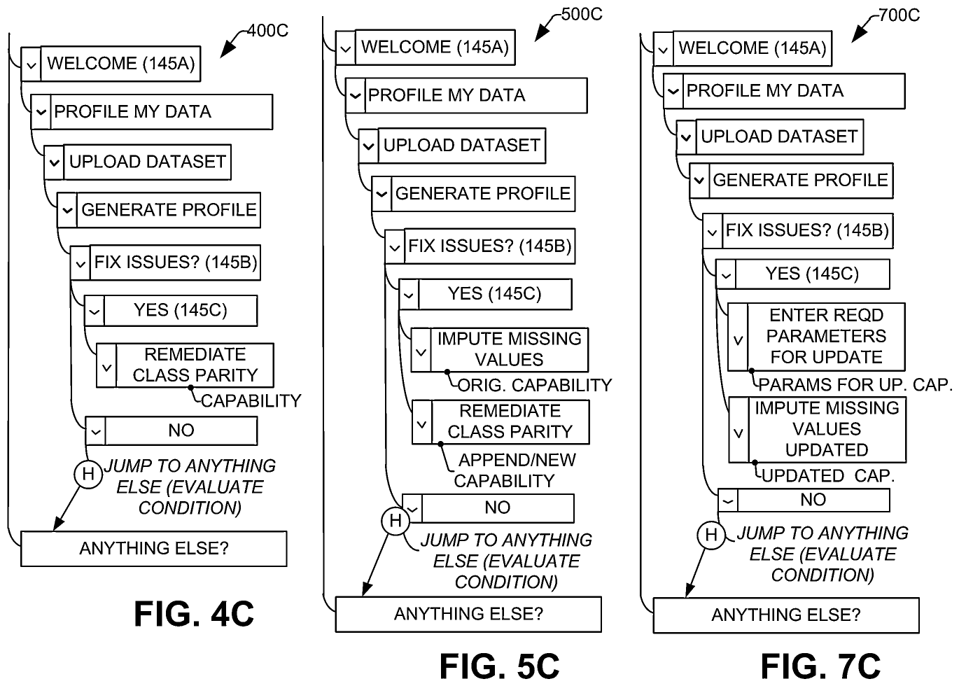

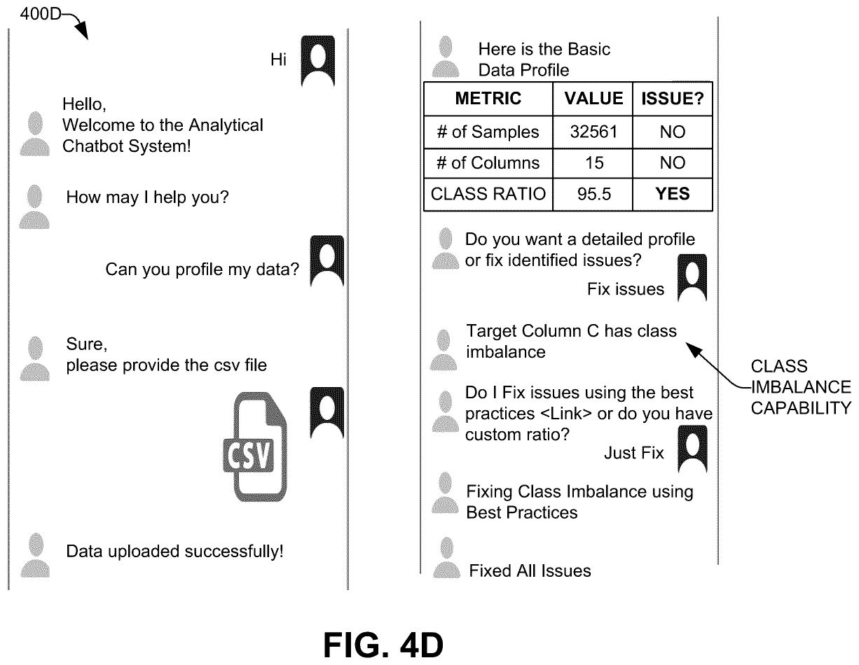

Turning to FIGS. 4A-D, images and schematics 400A-400D present various screens, flow charts, and dialog flows for implementing a capability according to one or more embodiments.

FIG. 4A, screen 400A presents an example exchange between a ACS and a user onboarding a new capability, in accordance with an embodiment. In an example scenario, a user U1 has access to a capability 121D (e.g., a class parity algorithm) and wants to onboard it to the ACS 100 (e.g., via the CAPI component 120), wherein capability 121D can be available in a toolbox of capabilities 121A-n/APIs 122A-n. As shown in FIG. 4A, the capability 121D has an associated API 122D, with metadata available at https:/classp, associated keywords Data Quality, Class Parity, Class Imbalance; a description regarding class parity is an algorithm that calculates imbalances of data point across a data set, inputs are data_file and label_column, output is a score between 0-1, and suchlike. Capability 121D can be a .csv file and the metadata, details can uploaded using any suitable file format, for example a JSON file. In response to the .csv file and data being uploaded, the ACS 100 can run a file complete check, with the capability added.

FIG. 4B presents a computer-implemented methodology 400B for incorporating a new capability into a dialog flow as a function of an associated API, in accordance with one or more embodiments.

At 410, the new capability (e.g., capability 121D) can be submitted to a ACS 100 (e.g., via CAPI component 120), where the capability can have an associated API (e.g., API 122D), wherein the API can further have associated therewith metadata, features, functionality, input parameter(s), output parameter(s), and suchlike. The capability, API, and associated properties can be can be stored (e.g., at the API hub 180).

At 420, the respective metadata, entities, intents, etc., associated with the capability/API can be identified/extracted (e.g., by API analyzer 134).

At 430, having extracted/identified the respective metadata, entities, intents, parameters, and suchlike for the capability/API, a similarity process can be performed (e.g., by API analyzer 134, similarity detection component 138) to determine whether any pre-existing APIs (e.g., in an AI toolbox in the API hub 180) have similar/comparable metadata, entities, intents, parameters, etc., to the metadata, entities, intents, parameters pertaining to the new capability/API.

At 440, If NO similar API is found (e.g., by similarity detection component 138) methodology 400 can advance to 450, wherein the ACS can create a new dialog 145D (e.g., by the clone dialog component 140) based upon a cloned/copied default dialog template.

At 460, in an embodiment, the default dialog template can comprise of various slots regarding various parameters, etc., which can be automatically populated with the metadata/parameters/intents/entities/etc., pertaining to the new capability/API (e.g., as fetched/extracted/identified by API analyzer 134). In an embodiment, in the event of the metadata pertaining to the new API does not provide all of the information required to populate the new dialog, a notification can be provided (e.g., by the CAPI component 120) to the user (e.g., user 1) requesting provision of the missing information, where the received missing information (e.g., from the user 1) can be inserted into the new dialog (e.g., by the clone dialog component 140). Accordingly, the ACS can auto-configure the new dialog as required to enable the new capability/API to be available for incorporation into a dialog tree/data flow (e.g., dialog tree 200A).

At 465, prior to publication of the dialog, the dialog can be presented to the user (e.g., user 1), wherein the user can confirm the parameters populating the dialog are correct and the dialog is acceptable for use.

At 470, the new dialog can be published (e.g., by the clone dialog component 140) for incorporation into a data tree (e.g., 200A). In an embodiment, the respective currently existing data trees can be reviewed (e.g., by the clone dialog component 140) to determine whether (a) the data tree pertains to the specific data tree and (b) where the new dialog should be inserted into the data tree (e.g., at node 210D) to cause operation of new capability/API to be triggered in response to an action at the node/new dialog causing execution of the new capability/API.

At 475, interaction between the ACS and a user (e.g., user 2) can be monitored (e.g., at the front-end system 161) regarding whether the dialog is to be presented (e.g., as part of a data flow), and further, how the user interacts with the dialog when presented. For example, a user (e.g., user U2) responds to the dialog (e.g., dialog 145D) being presented at the node (e.g., at node 210D) in a manner that triggers execution of the new capability/API, such as “dataset has class imbalance, fix class imbalance?”, to which the user responds “Yes”, wherein the new capability/API (e.g., class parity) is caused to be implemented upon the dataset.

Returning to 440, if YES a pre-existing API (e.g., API 124A-n) is found that is similar to the new API, methodology 400B can advance to 480 to identify a dialog associated with pre-existing similar API. In an embodiment, if it is determined that more than one pre-existing API is determined to be similar to the new API, the pre-existing API that is most similar to the new API can be selected and the dialog associated with the most similar API can be identified.

At 490 the dialog of the pre-existing API can be cloned (e.g., by the clone dialog component 140) to create a new standalone dialog for the new capability/API.

At 495, the cloned dialog can be updated to incorporate/fetch any required parameters, entity information, intent information, and suchlike, associated with the new capability/API, thereby configuring the newly cloned dialog as required to enable the new capability/API to be available for incorporation into a dialog tree/data flow (e.g., dialog tree 200A), along with any necessary triggers to enable activation of the cloned dialog and the new API. The newly cloned dialog can be published for incorporation into a data tree/data flow, as previously described at 470. The methodology 400B can advance to step 475, as previously described.

Turning to FIG. 4C, a dialog flow 400C is presented regarding dialog flow generated during user interaction with a virtual assistant during uploading of a new capability/API. In comparison with the dialog flow/screen 200C presented in FIG. 2D, the impute missing values capability dialog 145F that was present in FIGS. 2C and 2D has been replaced with the remediate class parity capability dialog 145D. Hence, when the dialog 145C is selected in the dialog flow 400C, the remediate class parity API is activated, compared to the impute missing values API that was presented when dialog 145C is selected in dialog flow/screen 200C.

Turning to FIG. 4D, a dialog flow 400D is presented regarding dialog flow generated during user interaction with a virtual assistant during uploading and executing of a new capability/API, in accordance with an embodiment. By comparison with the dialog flow presented in FIGS. 2B and 2C, the dialog sequence presented in dialog flow 400D shows the dialog referencing the impute missing values capability (a first capability) being replaced by the class parity capability dialog (a second capability). Wherein the class imbalance capability is invoked in response to the class ratio being flagged as an issue.

### 2. Update Existing Dialog-Append

Turning to FIGS. 5A-D, images and schematics 500A-500D present various screens, flow charts, and dialog flows for implementing a capability according to one or more embodiments.

FIG. 5A, screen 500A presents an example exchange between a user (e.g., user U1) and a ACS 100 (e.g., the CAPI component 120), in accordance with an embodiment. FIG. 5A repeats the example sequence of events presented in FIG. 4A whereby a user onboards a capability 121G (e.g., the same as CP capability 121D presented in FIGS. 4A-D), whereby the capability 121G has an associated API 122G, with metadata available at https:/classp, etc., as previously mentioned in FIG. 4A.

FIG. 5B presents a computer-implemented methodology 500B for incorporating a new capability into a dialog flow as a function of an associated API, in accordance with one or more embodiments. Steps 510 to 530 are comparable to steps 410 to 430 of FIG. 4B.

At 510, the new capability (e.g., capability 121G) can be submitted to a ACS (e.g., to ACS 100 vis the CAPI component 120), where the capability can have an associated API (e.g., API 122G), wherein the API can further have associated therewith metadata, features, functionality, input parameter(s), output parameter(s), and suchlike. The capability, API, and associated properties can be can be stored (e.g., at the API hub 180).

At 520, the respective metadata, entities, intents, etc., associated with the capability/API can be extracted (e.g., by API analyzer 134).

At 530, a similarity process can be performed (e.g., by API analyzer 134, similarity detection component 138) to determine whether any pre-existing APIs (e.g., in an AI toolbox in the API hub 180) have similar/comparable metadata, entities, intents, parameters, etc., to the metadata, entities, intents, parameters pertaining to the new capability/API.

At 540, if NO API is found having sufficient similarity to the new capability/API, methodology 500B can advance to 550, wherein a new dialog 145D can be generated based upon a default dialog template (e.g., dialog 145D using slot filling approach, for example, to fetch any required parameters and trigger the new API), as previously described in FIG. 4B, step 450. Methodology 500B can advance to 575, wherein functionality performed at steps 575 and 475 are comparable.

Returning to 540, in the event of pre-existing APIs are found that are similar the new API associated with the new capability (e.g., API 122G and capability 121G), at 560, the pre-existing dialogs (e.g., 145A-n) associated with the pre-existing APIs can be identified, in conjunction with the respective location of the dialogs in the respective dialog trees (e.g., dialog tree 200A) and pertinent nodes (e.g., 210A-n). Accordingly, the ACS can update (e.g., via the update dialog component 150) the existing dialog trees, enabling a user (e.g., user U2) to trigger the new capability/API from the existing dialog tree and associated dialog flow during interaction with the interface (e.g., the chatbot at front-end system 161). Further, the ACS can identify what new parameters (e.g., input parameters, output parameters, and suchlike) pertaining to the new capability/API are required to be added to the pre-existing dialogs to enable execution of the new capability/API.

At 570, the updated dialog with the new API/capability (and required parameters, etc.) appended to the pre-existing dialog(s) can be assigned to the respective nodes (e.g., nodes 210A-n) pertaining to presentment of the pre-existing dialog(s). Accordingly, the updated dialog(s) with the new API/capability appended thereto can be deployed for interaction with a user, e.g., via the chatbot. Methodology 500B can advance to 575, wherein functionality performed at steps 575 and 475 are comparable

Turning to FIG. 5C, as shown, a pre-existing dialog created from the original capability/API (e.g., impute missing values API/capability) has the newly created API/capability (e.g., class parity API/capability) incorporated/appended thereto. Hence, when the dialog is presented in the data tree, both the original capability/API and newly created API/capability are presented/available.

Turing to FIG. 5D, the dialog flow 500D shows both the impute missing values API/capability and the newly added remediate class parity API/capability being available and utilized during the interaction between a user and the chatbot. By comparison with the dialog flow presented in FIGS. 2B and 2C, the dialog flow of 500D has both capabilities presented (imputed missing value API and the class parity API) while the dialog flow/screen 200C only has the impute missing values capability.

### 3. Update Existing Dialog Based on Suggestion and Feedback

FIG. 6 presents a computer-implemented methodology 600 whereby a user can be prompted to authorize the results of automatically updating a pre-existing dialog with a new capability/API, in accordance with one or more embodiments.

Steps 610-640 are comparable to steps 510-540 presented in FIG. 5B (e.g., step 510=610, step 520=620, step 530=630, and step 540=640 regarding submission of a new capability to an ACS and further, determined whether a similar pre-existing API was found).

At 640, in the event of NO similar APIs were found, methodology 600 can advance to 650, wherein a default dialog can be generated (e.g., as previously described with reference to FIG. 4B, step 450 onwards).

At 640, in the event that YES, at least one pre-existing API is found (e.g., by the similarity detection component 138) having similar functionality as the new API associated with the new capability (e.g., API 122G and capability 121G), at 660, the pre-existing dialog(s) (e.g., 145A-n) associated with the at least one pre-existing API can be identified, in conjunction with the respective location of the dialogs in the respective dialog trees (e.g., dialog tree 200A) and pertinent nodes (e.g., 210A-n).

At 670, prior to the new capability/API being added to the at least one pre-existing dialog tree(s), the ACS can generate a notification (e.g., via CAPI component 120) to the user (e.g., user U1) indicating various determinations and recommendations the ACS has made regarding incorporating new capability/API into a dialog (e.g., based on entities, intents, etc.; potential node to incorporate in a dialog tree(s); slot filling, etc.).

At 680, a determination can be made (e.g., by the update dialog component 150) regarding whether the user has accepted the recommendation.

At 690, in response to a determination (e.g., by the update dialog component 150) of the user DID accept the one or more recommendations provided by the ACS, the ACS can incorporate the recommendation(s) regarding incorporating the new capability/API in the potential dialog(s), as well as inserting the modified dialog into the dialog tree at the recommended location. The methodology 600 can advance to 695, wherein functionality performed at steps 695, 575, and 475 are comparable.

Returning to step 680, in response to a determination that the user DID NOT accept one or more of the recommendations, methodology 600 can return to 620 wherein the ACS can be tasked (e.g., by feedback component 155, API analyzer 134, update dialog component 150, etc.) to review the recommendations that the user found to be unacceptable, and generate a new dialog. In a further embodiment, as part of the user rejecting the recommendations, the user can instruct the ACS to rollback the dialog to a prior version (e.g., to a version before the new capability/API was incorporated into the dialog, e.g., as stored in API hub 180). In another embodiment, methodology 600 can advance to 698, wherein, the user can edit one or more parameters, node locations, etc., and the user-generated updates can be incorporated into the dialog(s), node(s), etc. Methodology 600 can advance to 695, wherein functionality performed at steps 695, 575, and 475 are comparable.

### 4. Update Existing Dialog-Replace a Current Capability

In another embodiment, the user can notified of the existence of a pre-existing capability, and in response, the user can make a determination as to whether they want to replace the pre-existing capability with an updated version of the pre-existing capability or replace it with an entirely new capability. Turning to FIGS. 7A-C, images and schematics 700A-700C present various screens, flow charts, and dialog flows for replacing a current capability/API with a new capability/API, according to one or more embodiments.

FIG. 7A, screen 700A presents an example exchange between an ACS (e.g., via CAPI component 120) and a user (e.g., user U1), whereby the user wants to replace a currently existing capability with an updated version (e.g., updating the missing value imputation capability), and onboard the updated capability 121J to the ACS 100, wherein capability 121J can be available in a toolbox of capabilities 121A-n/APIs 122A-n. As shown in FIG. 7A, when prompted, the user can provide the details regarding the updated capability/API. The ACS 100 can subsequently obtain the features, parameters, functionality, etc., regarding the updated capability (e.g., by API analyzer 134). Based on the features, etc., identified for the updated capability/API, the ACS 100 can further identify (e.g., by API analyzer 134) the existing capability/API based on the similarity of features, parameters, etc., between those of the updated capability/API and the pre-existing version of the capability/API. In an embodiment, the respective features, parameters, etc., of the pre-existing capability/API and the updated capability/API can comprise respective metadata respectively stored for the pre-existing capability/API and the updated capability/API, with comparisons made (e.g., by API analyzer 134, update dialog component 150, etc.) between the metadata to (a) identify the pre-existing capability/API and (b) any changes that have to be made to the respective parameters, inputs, outputs, etc., to enable the updated capability/API to be triggered by a user during interaction with the analytical chatbot system (e.g., via a chatbot). Any suitable file type can be utilized for the API's, e.g., JSON files.

FIG. 7B presents a computer-implemented methodology 700B whereby a user can be prompted as to whether the user wishes to replace an existing capability/API with a new, updated capability/API, or add the new capability/API to an existing capability/API, in accordance with one or more embodiments.

Steps 710-740 are comparable to steps 510-540 presented in FIG. 5B (e.g., step 510=710, step 520=720, step 530=730, and step 540=740 regarding no similar pre-existing API was found). At 740, in response to NO API was found (e.g., by similarity detection component 138) having similar features, parameters, etc., to the new, updated capability/API, the methodology 700 can advance to 750, wherein a notification can be generated and provided to the user (e.g., user U1 via CAPI component 120) that no similar API was found. Methodology 700B can further advance to 755, wherein the interaction between the user can terminate, or other action taken to address why the comparable wasn't found, including approaching the updated capability/API as a new capability/API to be added (e.g., functionality performed at steps 755, 695, 575, and 475 are comparable).

At 740, in response to YES, at least one API was found (e.g., by the update dialog component 150) having comparable features, parameters, etc., as those pertaining to new/updated capability/API, a notification (e.g., by CAPI component 120) can be presented to the user (e.g., user U1) that an API has been identified having features, parameters, etc., comparable to the new capability/API that the user wants to implement.

At 760, a notification can be presented (e.g., by the update dialog component 150) regarding whether the user wishes to replace the pre-existing API with the new/updated capability/API.

At 770, in response to an instruction to replace the pre-existing API with the new/updated capability/API, respective dialogs (e.g., dialogs 145A-n) associated with the at least one pre-existing API can be identified (e.g., by API analyzer 134, update dialog component 150), in conjunction with the respective location of the dialogs in the respective dialog trees (e.g., dialog tree 200A) and pertinent nodes (e.g., 210A-n).

At 780, any new parameters, features, etc., pertaining to the new/updated capability/API required for the new/updated capability/API to function in the existing dialog(s) can be identified (e.g., API analyzer 134, update dialog component 150, etc.). For example, the differences between the original capability/API and the updated capability/API can be identified and updated accordingly (e.g., by the update dialog component 150).

At 790, the ACS can update the existing dialog tree(s) with the updated dialog(s), enabling a user (e.g., user U2) to trigger the new/updated capability/API from the existing dialog tree(s) and associated dialog flow during interaction with the interface (e.g., the chatbot at front-end system 161). Methodology 700B can further advance to 795, wherein functionality performed at steps 795, 695, 575, and 475 are comparable.

FIG. 7C presents a dialog flow 700C generated during user interaction with a virtual assistant after a capability/API has been updated with a more recent version, in accordance with an embodiment. In an embodiment, the imputed missing values API can be updated, wherein the updated API can also require further parameters to be entered prior to the updated imputed missing values API being is activated. Hence, as shown in FIG. 7C, as the dialog flow 700C is navigated (e.g., in response to activity by user U2), at dialog 145C, parameters can be entered in view of loading/invoking the updated imputed missing values capability. Hence, with reference to FIG. 2A, node 210E (sibling node) can be the node at which the imputed missing values API 121P is activated, wherein node 210C can be the node at which the required parameters are entered, wherein node 210C is the prior sibling node to node 210E, and further, node 210A can be the parent node to both nodes 210C and 210E.

Per the foregoing, various embodiments are presented regarding applying AI technology to various capabilities/APIs, identifying respective dialog trees that the various capabilities/APIs pertain to, determining incorporation and activation of the respective capabilities/APIs as a virtual conversation is undertaken. Hence, the various embodiments provide a level of automated intelligence to a chatbot system that is not possible to achieve by a human operator, particularly as the number of capabilities/APIs/dialog trees/dialogs/nodes/etc., run into the tens, hundreds, thousands as a chatbot system increases in complexity over time.

### Example Applications and Use

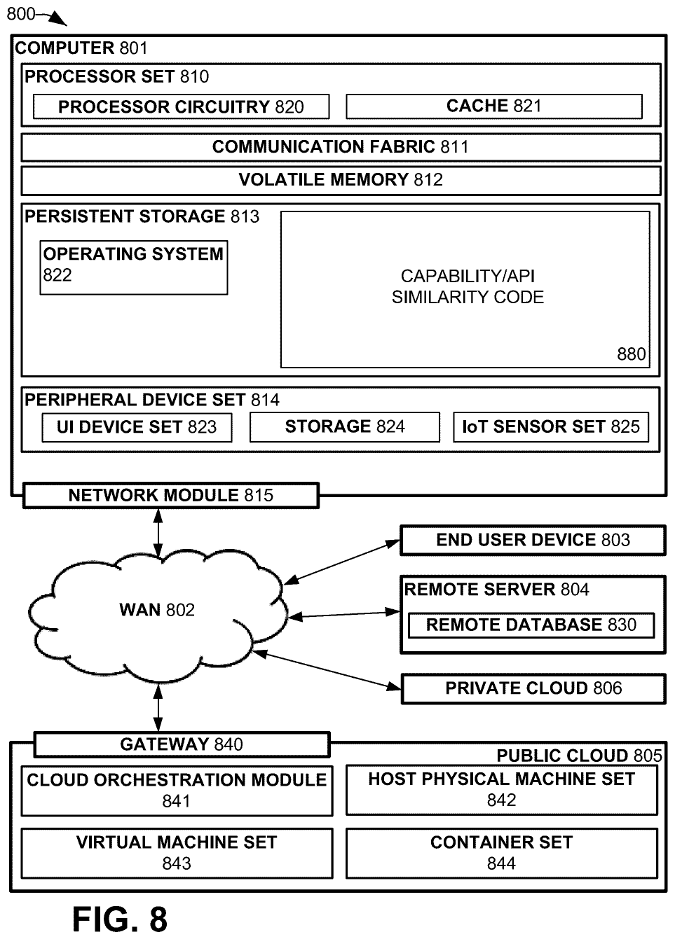

FIG. 8 and the following discussion are intended to provide a brief, general description of a suitable computing environment 800 in which one or more embodiments described herein at FIGS. 1-7C can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing inventive methods such as identifying the existence of pre-existing capabilities/APIs having a respective similarity as a new capability/API, and utilizing the similarity/or lack of similarity to determine how to incorporate a new capability/API into a dialog, wherein the dialog forms part of a dialog tree presented, e.g., via a chatbot, per capability/API similarity code 880. In addition to block 880, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 880, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method can be distributed among multiple computers and/or between multiple locations. On the other hand, in this presentation of computing environment 800, detailed discussion is focused on a single computer, specifically computer 801, to keep the presentation as simple as possible. Computer 801 can be located in a cloud, even though it is not shown in a cloud in FIG. 8. On the other hand, computer 801 is not required to be in a cloud except to any extent as can be affirmatively indicated.

PROCESSOR SET 810 includes one, or more, computer processors of any type now known or to be developed in the future. Processing circuitry 820 can be distributed over multiple packages, for example, multiple, coordinated integrated circuit chips. Processing circuitry 820 can implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set can be located “off chip.” In some computing environments, processor set 810 can be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods can be stored in block 880 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory can be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 can be a read only memory (ROM), but typically at least a portion of the persistent storage allows writing of data, deletion of data and re-writing of data. Some familiar forms of persistent storage include magnetic disks and solid-state storage devices. Operating system 822 can take several forms, such as various known proprietary operating systems or open-source Portable Operating System Interface type operating systems that employ a kernel. The code included in block 880 typically includes at least some of the computer code involved in performing the inventive methods.

PERIPHERAL DEVICE SET 814 includes the set of peripheral devices of computer 801. Data communication connections between the peripheral devices and the other components of computer 801 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 can include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 can be persistent and/or volatile. In some embodiments, storage 824 can take the form of a quantum computing storage device for storing data in the form of qubits. In embodiments where computer 801 is required to have a large amount of storage (for example, where computer 801 locally stores and manages a large database) then this storage can be provided by peripheral storage devices designed for storing large amounts of data, such as a storage area network (SAN) that is shared by multiple, geographically distributed computers. IoT sensor set 825 is made up of sensors that can be used in Internet of Things applications. For example, one sensor can be a thermometer and another sensor can be a motion detector.

NETWORK MODULE 815 is the collection of computer software, hardware, and firmware that allows computer 801 to communicate with other computers through WAN 802. Network module 815 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801) and can take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 can be a client device, such as thin client, heavy client, mainframe computer and/or desktop computer.

REMOTE SERVER 804 is any computer system that serves at least some data and/or functionality to computer 801. Remote server 804 can be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data can be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs can be stored as images and can be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware and firmware allowing public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the Figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a dialog generator component configured to:
determine at least one property of a first application programming interface (API) code; and
determine existence of a second API based on the second API having a property similar to the at least one property of the first API, wherein the second API has an associated dialog configured to be presented during a virtual conversation.

2. The system of claim 1, wherein the dialog generator component is further configured to:
in response to a determination that a second API exists similar to the first API, identifying the dialog associated with the second API; and
incorporating the first API into the dialog, wherein the dialog comprises the first API and the second API.

3. The system of claim 1, wherein the dialog generator component is further configured to:
in response to a determination that a second API exists similar to the first API, identifying the dialog associated with the second API; and
replacing the second API in the dialog with the first API.

4. The system of claim 3, wherein the dialog generator component is further configured to:
identify a dialog tree that pertains to the at least one property of the first API; and
identify a node in the dialog tree at which to insert the dialog comprising the first API.

5. The system of claim 4, further comprising a human-machine-interface (HMI), wherein the HMI is configured to present, during the virtual conversation, the dialog comprising the first API; and
the dialog generator component is further configured to:
determine interaction with the dialog comprising the first API; and
in response to a determination that the interaction requires activation of the first API, executing the API.

6. The system of claim 5, further comprising a feedback component configured to:
receive feedback regarding at least one of the activation of the API, the correlation between the API and a task to be performed, correlation between the API and a theme of the dialog tree, or location of the API in the dialog tree structure.

7. The system of claim 6, wherein the feedback component is further configured to:
generate feedback information based on the received feedback; and
transmit the feedback information to the dialog generator component; and
wherein the dialog generator component is further configured to:
receive the feedback information; and
based on the feedback information, review a location of the dialog in the dialog tree or the suitability of the first API regarding at least one of a theme of the dialog tree or a task being conducted during the virtual conversation.

8. The system of claim 1, wherein the dialog generator component is further configured to:
in response to a determination that a second API having a similar property to the at least one property of the first API does not exist, identifying a dialog template;
generating a dialog based on the dialog template; and
incorporating the first API into the dialog.

9. The system of claim 1, wherein the dialog generator component is further configured to:
in response to a determination that a second API having a similar property to the at least one property of the first API exists, identifying the dialog associated with the second API;
cloning the dialog to create a cloned version of the dialog associated with the second API, and
incorporating the first API into the cloned dialog.

10. The system of claim 1, wherein the at least one property includes an entity or an intent.

11. The system of claim 1, further comprising a chatbot, wherein the virtual conversation is presented via the chatbot.

12. A computer-implemented method performed by a device operatively coupled to a processor, wherein the method comprising:
determining at least one property of a first application programming interface (API) code; and
determining existence of a second API based on the second API having a property similar to the at least one property of the first API, wherein the second API has an associated dialog configured to be presented during a virtual conversation.

13. The computer-implemented method of claim 12, further comprising:
in response to determining that a second API exists similar to the first API:
identifying the dialog associated with the second API; and
incorporating the first API into the dialog, wherein the dialog comprises the first API and the second API, wherein the first API is incorporated into the dialog by:
replacing the second API with the first API to create a dialog comprising the first API; or
appending the second API with the first API to create a dialog comprising the first API and the second API.

14. The computer-implemented method of claim 13, further comprising:
identifying a dialog tree pertaining to the at least one property of the first API; and
identifying a node in the dialog tree at which to insert the dialog comprising the first API.

15. The computer-implemented method of claim 13, further comprising:
determining interaction with the dialog comprising the first API; and
in response to determining the interaction requires activation of the first API, executing the API.

16. The computer-implemented method of claim 12, further comprising:
in response to determining that a second API having a similar property to the first API does not exist:
generating a second dialog; and
incorporating the first API into the second dialog, wherein the second dialog comprises the first API.

17. A computer program product comprising a computer readable storage medium having program instructions embodied therewith, the program instructions executable by a processor to cause the processor to:
determine at least one property of a first application programming interface (API) code; and
determine existence of a second API based on the second API having a property similar to the at least one property of the first API, wherein the second API has an associated dialog configured to be presented during a virtual conversation.

18. The computer program product of claim 17, wherein the program instructions are further executable by the processor to cause the processor to in response to determining that a second API exists similar to the first API:
identifying the dialog associated with the second API; and
incorporating the first API into the dialog, wherein the dialog comprises the first API and the second API, wherein the first API is incorporated into the dialog by:
replacing the second API with the first API to create a dialog comprising the first API; or
appending the second API with the first API to create a dialog comprising the first API and the second API.

19. The computer program product of claim 17, wherein the at least one property includes an entity or an intent.

20. The computer program product of claim 17, wherein the program instructions are further executable by the processor to cause the processor to present the virtual conversation via a chatbot.
